(19) United States
(12) Patent Application Publication
(10) Pub. No.: US 2010/0087227 A1
(43) Pub. Date: Apr. 8, 2010

(54) WIRELESS BASE STATION DESIGN

(75) Inventors: Amir FRANCOS, Tel-Aviv (IL); Anatoly Sloushch, Natania (IL); David Shechter, RaAnana (IL)

Correspondence Address: MARTIN D. MOYNIHAN d/b/a PRTSI, INC., P.O. BOX 16446, ARLINGTON, VA, 22215, US

(73) Assignee: Alvarion Ltd., Tel-Aviv (IL)

(21) Appl. No.: 12/244,014

(22) Filed: Oct. 2, 2008

(51) Int. Cl. H04M 1/00; H04L 25/49; H04B 1/38; H04B 17/00

(52) U.S. Cl. 455/562.1; 375/296; 375/221; 375/219

(57) ABSTRACT

A multi-transmitter base station for wireless digital communication, having beam forming and digital pre-distortion capabilities, including a shared feedback unit for providing feedback of outgoing Radio Frequency (RF) signals for calibrating a plurality of antennas and for adapting the digital pre-distortion. Related apparatus and methods are also described.

### FIELD AND BACKGROUND OF THE INVENTION

The present invention, in some embodiments thereof, relates to a wireless network base station, and, more particularly, but not exclusively, to a wireless WiMax network base station.

Wireless network base stations of many types are produced by many manufacturers.

Some features which some wireless network base stations might have are:

Digital Pre-Distortion (DPD) of wireless signals; and

Beam forming (BF) for the purpose of aiming a wireless beam at a wireless receiver, and nulling, for the purpose of significantly lowering wireless energy arriving at an undesired receiver.

Common practice today performs calibration of antenna arrays for the purpose of Beam Forming (BF), BF combined with nulling, and Down Link-Spatial Division Multiple Access (DL-SDMA), either using an external calibration unit, or using a self-calibration mechanism. The calibration scheme requires external radio hardware and control mechanisms to control and synchronize calibration transmissions and modem transmissions. Self-calibration schemes which currently exist in the art use additional components for calibration. The majority of self-calibration schemes currently available today for eigenbeamforming discuss reciprocal calibration in which per each chain a Tx path is calibrated versus a Rx path, such that a relation between the Tx and the Rx transfer functions fulfills: H_Tx(f)≅H_Rx(f).

Additional background art includes:

reference 1: the IEEE standard 802.16e -2005/cor2-D4;

reference 2: the WiMax Forum Mobile Technical Group (MTG) document “Mobile WiMax system profile V0[1].1.2”;

PCT Published Patent Application 2003/019773 of TELEFONAKTIEBOLAGET LM ERICSSON;

PCT Published Patent Application 2001/08294 of DATUM TELEGRAPHIC INC.; and

CN Published Patent Application 1815914A, of which the abstract describes: “Besides normal states of receiving and transmitting channel, the disclosed receiver and transmitter in radio frequency also possesses calibration states. In time of calibrating transmitting channel, the method lets two sets of receiver and transmitter of calibration work at calibration state of receiving channel to receive a calibration signal; and other receivers and transmitters work at normal state to transmit calibration signals. The method obtains each two times of test data of each transmitting channel. In time of calibrating receiving channel, the method lets two sets of receiver and transmitter of calibration work at calibration state of transmitting channel in sequence to transmit calibration signal; and other receivers and transmitters work at normal state to receive calibration signals. The method obtains each two times of tested data of each receiving channel. Based on the said two times of tested data, the method calibrates receiving and transmitting channels.”

### SUMMARY OF THE INVENTION

The present invention, in some embodiments thereof, relates to a design of a wireless network base station. The design is modular, in some embodiments, optionally enabling support of multiple radio units, multiple base-band units, and/or multiple carrier signals, with minimal or no redesign of the base station. The modularity optionally enables reuse of modules in different applications of a wireless network base station, and optionally enables minimal redesign of some modules while using other modules with no redesign.

The design also shares hardware components among different functions of the base station, so that the number of components is minimized. Minimizing the number of components provides many benefits, among which are, by way of a non-limiting list: less heat production; ability to place a base station outdoors, where heat production is considered a problem which the present design ameliorates; less components to calibrate; automatic alignment of the functions sharing the same components, lower cost, and so on. Some components are optionally shared among different functions by using Time Division Multiplexing (TDM).

According to an aspect of some embodiments of the present invention there is provided a multi-transmitter base station for wireless digital communication, having beam forming and digital pre-distortion capabilities, including a shared feedback unit for providing feedback of outgoing Radio Frequency (RF) signals, for calibrating a plurality of antennas, and for adapting the digital pre-distortion.

According to some embodiments of the invention, the base station further includes multiple receivers, in which at least one receiver shares components with the shared feedback unit.

According to some embodiments of the invention, there is only one analog Radio-Frequency (RF) Local Oscillator (LO). According to some embodiments of the invention, the one analog RF LO is used simultaneously for transmitting, receiving, and providing feedback for calibration.

According to some embodiments of the invention, the base station further includes multiple receivers, in which at least one receiver shares a RF LO with at least one transmitter.

According to some embodiments of the invention, the base station includes a base band unit which receives input of digital communication and encodes the digital communication, a radio unit which accepts an input including the encoded digital communication at an intermediate frequency (IF) substantially lower than the RF LO frequency, a Radio-Frequency (RF) Local Oscillator (LO) which is included in the radio unit, and the base station is packaged in a plurality of enclosures. According to some embodiments of the invention, the radio unit is configured to accept an Open Base Station Architecture Initiative (OBSAI) compliant input. According to some embodiments of the invention, the radio unit is configured to accept a Common Public Radio Interface (CPRI) compliant input. According to some embodiments of the invention, the radio unit is configured to accept an optical input. According to some embodiments of the invention, one or more of the enclosures are packaged for outdoors operation.

According to an aspect of some embodiments of the present invention there is provided a multi-transmitter base station for wireless digital communication, having a feedback unit acting as a mux/demux for all feedback and calibration signals, shunting the feedback and calibration signals to their respective destinations.

According to some embodiments of the invention, the feedback unit shares some components with a receive path

According to an aspect of some embodiments of the present invention there is provided a multi-transmitter base station for wireless digital communication including multiple receivers, in which at least one receiver shares an analog RF LO with at least one transmitter. According to some embodiments of the invention, there is only one analog RF LO. According to some embodiments of the invention, the base station further includes multiple receivers, in which all receivers share the analog RF LO with all transmitters.

According to an aspect of some embodiments of the present invention there is provided a method of calibration in a multi-receiver base station for wireless digital communication having at least one transmit path including providing a transmission signal through the transmit path, prior to power amplification, routing the transmission signal, back through a plurality of receive paths, and measuring transfer functions of signals by comparing the transmission signal to signals received through the plurality of the receive paths.

According to some embodiments of the invention, the transmission signal is shunted from the transmit path prior to power amplification, and the routing back through a plurality of receive paths includes feeding the transmission signal to receive antennas.

According to some embodiments of the invention, the routing further includes routing the transmission signal back through the plurality of receive paths using a shared feedback unit.

According to some embodiments of the invention, the providing, routing, and measuring are performed at least once for each of a plurality of different signal frequencies.

According to some embodiments of the invention, the routing the transmission signal is performed by a shared feedback unit.

According to some embodiments of the invention, at least some of the plurality of receive paths are calibrated, based, at least partly, on the measuring.

According to some embodiments of the invention, at least some of the plurality of receive paths share one Radio-Frequency (RF) Local Oscillator (LO). According to some embodiments of the invention, all of the plurality of receive paths share the one RF LO.

According to some embodiments of the invention, at least some of the plurality of receive paths include a SAW filter.

According to an aspect of some embodiments of the present invention there is provided a method of calibration in a multi-transmitter base station for wireless digital communication having at least one receive path including providing a transmission signal through a plurality of transmit paths, routing the transmission signal back through the receive path, and measuring transfer functions of signals by comparing the transmission signal to signals received through each one of at least some of the plurality of transmit paths and the receive path.

According to some embodiments of the invention, the routing further includes routing the transmission signal back through the reception path using a shared feedback unit.

According to some embodiments of the invention, the providing, routing, and measuring are performed at least once for each of a plurality of different signal frequencies.

According to some embodiments of the invention, the routing the transmission signal is performed by a shared feedback unit.

According to some embodiments of the invention, at least some of the plurality of transmit paths is calibrated based, at least partly, on the measuring.

According to some embodiments of the invention, at least some of the plurality of transmit paths share one Radio-Frequency (RF) Local Oscillator (LO). According to some embodiments of the invention, the receive path shares the one RF LO. According to some embodiments of the invention, all of the plurality of transmit paths share the one RF LO.

According to some embodiments of the invention, at least some of the plurality of transmit paths include a SAW filter.

According to an aspect of some embodiments of the present invention there is provided a method for calibrating receive paths and transmit paths in a base station for wireless digital communication having a plurality of receive paths and transmit paths including providing a first transmission signal through a transmit path, prior to power amplification, routing the first transmission signal back through a plurality of receive paths, measuring a first set of transfer functions by comparing the first transmission signal to signals received through at least some of the plurality of the receive paths, providing a second transmission signal through a plurality of transmit paths, routing the second transmission signal back through a receive path, measuring a second set of transfer functions of signals by comparing the second transmission signal to a signal received through at least some of the plurality of transmit paths and the receive path, and calibrating at least some of the transmit paths and receive paths based, at least partly, on the first set and the second set.

According to some embodiments of the invention, the routing the first to transmission signal and the routing the second transmission signal include routing via a shared feedback unit.

According to some embodiments of the invention, the providing, routing, measuring and calibrating are performed at least once for each of a plurality of different signal frequencies.

According to some embodiments of the invention, routing the first transmission signal and routing the second transmission signal are performed by a shared feedback unit.

According to an aspect of some embodiments of the present invention there is provided a method for transmitting via multiple transmit paths in a multi-transmitter base station for wireless digital communication including sharing a single Radio-Frequency (RF) Local Oscillator (LO) between more than one transmit path.

According to an aspect of some embodiments of the present invention there is provided a multi-transmitter base station for wireless digital communication configured to perform self calibration of a plurality of receive paths, in which at least some of the plurality of receive paths share a Radio-Frequency (RF) Local Oscillator (LO), including means for providing a transmission signal through a transmit path, means for routing the transmission signal, prior to power amplification, back through the plurality of receive paths, and means for measuring transfer functions of signals by comparing the transmission signal to signals received through the plurality of the receive paths.

According to some embodiments of the invention, all of the plurality of receive paths share the one RF LO.

According to an aspect of some embodiments of the present invention there is provided a multi-transmitter base station for wireless digital communication configured to perform self calibration of a plurality of transmit paths, in which at least some of the plurality of transmit paths share a Radio-Frequency (RF) Local Oscillator (LO), including means for providing a transmission signal through the plurality of transmit paths, means for routing the transmission signal back through a receive path, and means for measuring transfer functions of signals by comparing the transmission signal to signals received through each one of at least some of the plurality of transmit paths and the receive path.

According to some embodiments of the invention, all of the plurality of transmit paths share the one RF LO.

According to an aspect of some embodiments of the present invention there is provided a multi-transmitter base station for wireless digital communication including a base band unit which receives input of digital communication and encoding the digital communication, configured for digital operation at frequencies lower than Radio Frequency (RF), and a radio unit which operates at frequencies including RF, wherein the base band unit and the radio unit communicate with each other at frequencies lower than RF, the base band unit and the radio unit are packaged in separate modular units, and the base station is configured to include a plurality of at least one of the base band unit and the radio unit.

According to some embodiments of the invention, the base band unit and the radio unit communicate with each other using a physical connection from the group consisting of a wire connection and an optical fiber. According to some embodiments of the invention, the base band unit and the radio unit are configured to communicate with each other at an Intermediate Frequency (IF). According to some embodiments of the invention, the base band unit and the radio unit are configured to communicate with each other at a base band frequency.

According to some embodiments of the invention, the base station is configured so that base band units can be added to the base station. According to some embodiments of the invention, the base station is configured so that radio units can be added to the base station.

According to an aspect of some embodiments of the present invention there is provided a multi-transmitter base station for wireless digital communication including a master unit configured to supply Radio-Frequency (RF) Local Oscillator (LO) signals for the base station, and one or more auxiliary units configured to receive the RF LO signals from the master unit and provide functionality of at least one of a transmit path and a receive path.

According to some embodiments of the invention, the master unit provides all the RF LO signals for the base station. According to some embodiments of the invention, the master unit provides clock signals for the base station. According to some embodiments of the invention, the master unit provides all the clock signals for the base station.

According to some embodiments of the invention, the base station is configured so that auxiliary units can be added to the base station and receive the RF LO signals from the master unit, and the auxiliary units are configured to receive the RF LO signals from the master unit and provide the functionality.

According to some embodiments of the invention, the base station is configured so that the auxiliary units can be removed from the base station, and the auxiliary units remaining in the base station are configured to continue to receive the RF LO signals from the master unit and to provide the functionality.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

### BRIEF DESCRIPTION OF THE DRAWINGS

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified block diagram of a base station constructed and operative in accordance with an exemplary embodiment of the present invention;

FIG. 1B is a simplified block diagram of a shared feedback unit in an exemplary embodiment of the base station of FIG. 1A;

FIG. 2 is a simplified block diagram of a shared feedback path in an exemplary single enclosure MIMO base station embodiment of the base station of FIG. 1A;

FIG. 3 is a more detailed simplified block diagram of a shared feedback path in an alternative embodiment of the base station of FIG. 1A;

FIG. 4 is a simplified block diagram of a transmission (Tx) path of an exemplary embodiment of the base station of FIG. 1A;

FIG. 5A is a simplified block diagram of a reception (Rx) path of an exemplary embodiment of the base station of FIG. 1A;

FIG. 5B is a simplified block diagram of a shared feedback unit in an exemplary embodiment of the base station of FIG. 1A;

FIG. 5C is a simplified block diagram of an alternative exemplary embodiment of the shared feedback unit in an exemplary embodiment of base station of FIG. 1A, showing shared components with an exemplary receive (Rx) path;

FIG. 5D is a simplified block diagram of another alternative exemplary embodiment of the shared feedback unit in an exemplary embodiment of the base station of FIG. 1A;

FIG. 5E is a simplified block diagram of yet another alternative exemplary embodiment of the shared feedback unit in an exemplary embodiment of the base station of FIG. 1A, showing shared components with an exemplary receive (Rx) path;

FIG. 6 is a simplified graphic description of selection of a required signal replica in the receive path (Rx) of FIG. 5A;

FIG. 7 is a simplified diagram of a principle of operation of the base-band to radio unit interface of the base station of FIG. 1A;

FIG. 8 is a simplified diagram of high level connectivity of a single chain base-band unit and radio unit in the base station of FIG. 1A;

FIG. 9 is a simplified block diagram of interpolations in a single Tx path in the base station of FIG. 1A;

FIG. 10 is a simplified block diagram of a single chain Rx path in the base station of FIG. 1A;

FIG. 11 is a simplified block diagram illustration of a calibration path in the base station of FIG. 1A; and

FIG. 12 is a simplified block diagram illustration of a SAW calibration path in the base station of FIG. 1A.

### DESCRIPTION OF SPECIFIC EMBODIMENTS OF THE INVENTION

The present invention, in some embodiments thereof, relates to a wireless network base station, and, more particularly, but not exclusively, to a wireless WiMax network base station.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention, in some embodiments thereof, relates to a design of a wireless network base station. The design is modular, thereby enabling support of multiple radio units, multiple base-band units, and multiple carrier signals, with minimal or no redesign of the base station. The design provides a platform for applications such as MIMO, beam forming (BF) and DL-SDMA.

A base station may be housed in more than one enclosure. By way of a non-limiting example, a base station may have one enclosure housing units operating at base-band and intermediate frequencies and one or more additional enclosures housing units operating at radio frequencies. By way of another example the base station may have only one enclosure housing all of its components. By way of another example the base station may have one or more of its enclosures designed for outdoor locations, using less power, and/or having different heat dispersion, and/or being differently sealed against the elements.

The base station is defined by virtue of its components being used for routing communication signals to a set of subscribers. Base stations are defined as separate if they do not share components, except possibly sharing a power supply and/or an enclosure.

The design also includes sharing hardware components among different functions of the base station, so that the number of components is reduced. Reducing the number of components provides many benefits, among which are, by way of a non-limiting list: energy efficiency; less heat production; ability to place a base station outdoors, where heat production is considered a problem which the present design ameliorates; fewer components to calibrate; automatic alignment of the functions sharing the same components, lower cost, and so on.

The design, in some embodiments thereof, is a design for a base station configured for outdoor installation and use.

A base station receiver chain optionally contains a single analog conversion, using a single analog Local Oscillator (LO). The single LO results in a lowered number of analog components, which lowers noise, in particular, in comparison to a design of a classic super-heterodyne receiver, which requires two analog conversions.

The design, in some embodiments thereof, is believed to be a lower noise design than currently available, by approximately 2 [dB].

Noise is reduced, relative to conventional designs, due to the architecture chosen and the fact that the number of components is minimized. One example of architecture choice is that the same LO is shared between Tx paths, Rx paths, and a shared feedback path. Another example of architecture choice is an Rx path design which has a single analog conversion unit, and thus saves components, such as filters, oscillators, and amplifiers. Typically, 4 to 5 components are saved. As a consequence of reducing component count, noise in the system is reduced, since each component has a self noise. By reducing the number of analog components, noise is minimized.

By way of a non-limiting example, the noise figure of the self noise of the Rx path of an example embodiment of the invention is less than or equal to 4 [dB], while in a conventional design which has two analog RF frequency converters the noise figure is believed to be close to 6 [dB].

Some embodiments of the invention include only one analog Local Oscillator (LO) shared among multiple units.

Some embodiments of the invention use digital high Intermediate Frequency (high-IF) techniques and components, which can eliminate a need for conventional super-heterodyne transceivers.

Some embodiments of the invention use low-IF techniques and components.

Some embodiments of the invention use no IF techniques and components. Such embodiments are termed zero-IF.

Some embodiments of the invention include digital pre-distortion techniques using digital techniques and components, which provides a high efficiency radio unit.

Some embodiments of the invention include digital crest factor reduction techniques, which provide a high efficiency radio unit.

Some embodiments of the invention perform Digital Pre Distortion (DPD) using one feedback unit for multiple transmission (Tx) paths. Some embodiments of the invention perform Digital Pre Distortion (DPD) using more than one feedback unit.

The term “path” in all its grammatical forms is used throughout the present specification and claims interchangeably with the term “chain” and its corresponding grammatical forms.

Some embodiments of the invention calibrate antenna transmissions. Some embodiments of the invention calibrate antenna transmissions for beam forming and/or DL-SDMA optionally using the same feedback unit as for DPD, optionally by using TDM. Some embodiments of the invention calibrate antenna transmissions for nulling using the same feedback unit as for DPD, optionally by using TDM.

Some embodiments of the invention calibrate Surface Acoustic Wave (SAW) filters in the base station by using the same feedback unit as for DPD, optionally by using TDM. It is noted that some components of the invention, such as SAW filters, are temperature dependent, and optionally require re-calibration every so often.

Some embodiments of the invention combine internal calibration for reciprocal beam forming with a shared DPD feedback for transmitter to transmitter calibration, providing a calibration scheme which is accurate enough for DL-SDMA, which requires to sub-sector directed beams, and reducing intra-sector handovers.

Following is a description of an example embodiment of the invention.

Overview

The example embodiment of the invention is a single sector mobile WiMax base station. The embodiment is optionally suitable for outdoor placement and operation. The embodiment offers a cost-effective base station with a reduced form-factor, relative to present state-of-the-art, and includes an optionally outdoor installable enclosure. The architecture of the embodiment supports both an outdoor base station and a macro base station.

It is noted that embodiments of the invention are not limited to a single sector base station, and may be multiple sector, such as, by way of a non-limiting example, three sector.

An embodiment of the invention suitable for outdoor installation optionally includes a reduced feature set, relative to an indoor installation, a reduced output power, relative to an indoor installation, and so on. The embodiment of the invention suitable for outdoor installation also optionally includes mechanical features suitable for outdoor installation, such as waterproofing, passive heat dispersion, appropriate sealing, and so on.

Embodiments of the invention support both a single-box configuration, where base-band and radio-head functionality are included in one enclosure; and a multiple-box configuration, where base-band functionality and radio-head functionality are in separate, optionally outdoor, enclosures operatively connected via an interface, such, by way of a non-limiting example, an Open Base Station Architecture Initiative (OBSAI) interface.

It is noted that placing a radio head unit outdoors in a position exposed to client units, such as on a mast, is often desirable. Placing a base band unit outdoors is sometimes desirable, and sometimes it is convenient to have the base band unit indoors. Embodiments of the invention enable the above configurations.

Following is a list of some optional features of an example embodiment:

maximal output power per chain is optionally 34-43 [dBm]; power amplifier efficiency is optionally higher than 35% at the antenna connector, and Digital Pre-Distortion (DPD) technology is optionally used in order to increase efficiency;

total radio bandwidth is optionally maximally 20 Mhz; carrier signal bandwidths are optionally 5, 7, 10, and 20 Mhz; the number of carrier signals is optionally one or more;

frequency bands and bandwidths which are supported, optionally one at a time, are a frequency band of 2.5-2.7 GHz: 2.496-2.69 Time Division Duplexing (TDD) at bandwidths of 5, 7, 10 and 20 Mhz, a frequency band of 3.4-3.6 GHz: 3400-3455, 3445-3500, 3500-3555, 3545-3600, a frequency band of 2.3-2.4 GHz: 2.305-2.320, 2.345-2.360 TDD at bandwidths of 5, 7, 10 and 20 Mhz, and 3.3-3.4 & 3.6-3.8 TDD;

base band units and radio units are optionally in a single box enclosure, but if not, optionally include a commonly accepted optical interface standard such as OBSAI;

antenna configurations which are optionally supported include 2×2 Space Time Coding (STC) and Multiple In Multiple Out (MIMO), 4×2 for diversity expansion, and 4×4 for beam-forming expansion; and

smart antenna techniques which are optionally supported include: STC; Model Reference Robust Control (MRRC); N×MIMO antenna technology UpLink/DownLink (UL/DL); and Beam-Forming (BF), and combinations thereof, such as, by way of a non-limiting example: only MIMO; only BF; both BF and MIMO in different zones; and BF+MIMO.

The example embodiment implements an aggressive form-factor and Power Amplifier (PA) efficiency and techniques, such as Digital Pre-Distortion (DPD) and Crest Factor Reduction (CFR).

The optional support of beam-forming also optionally adds support for calibration functionality. One optional embodiment uses four transmit antennas for beam-forming.

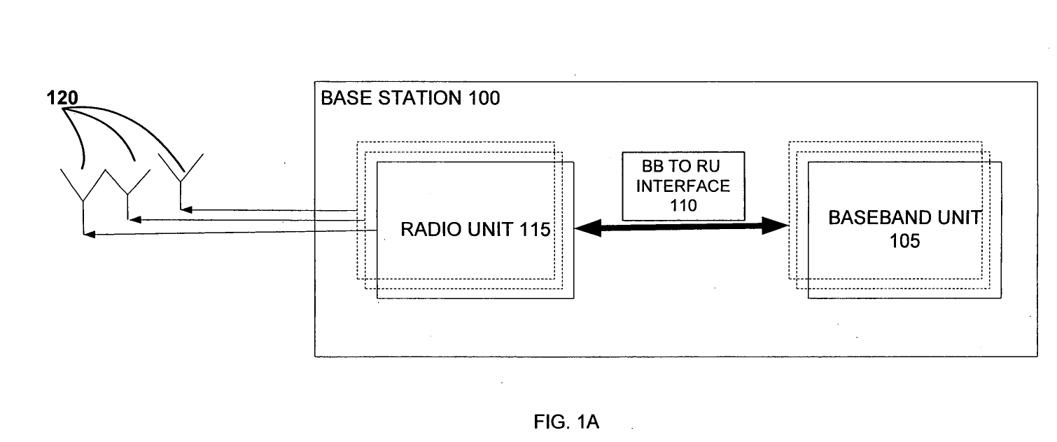

Reference is now made to FIG. 1A, which is a simplified block diagram of a base station 100 constructed and operative in accordance with an exemplary embodiment of the present invention.

The base station 100 depicted in FIG. 1A comprises one or more base-band units 105, a base-band to radio unit interface 110, one or more radio units 115, and one or more antennas 120.

The term “radio unit” (RU) in all its grammatical forms is used throughout the present specification and claims interchangeably with the term “radio head” (RH) and its corresponding grammatical forms.

The base-band unit 105 provides a Remote Radio Module (RRM) control functionality, and data path MAC and PHY functionality. Output of the base-band unit includes a physical signal sampled at a base-band frequency as defined by the 802.16e standard.

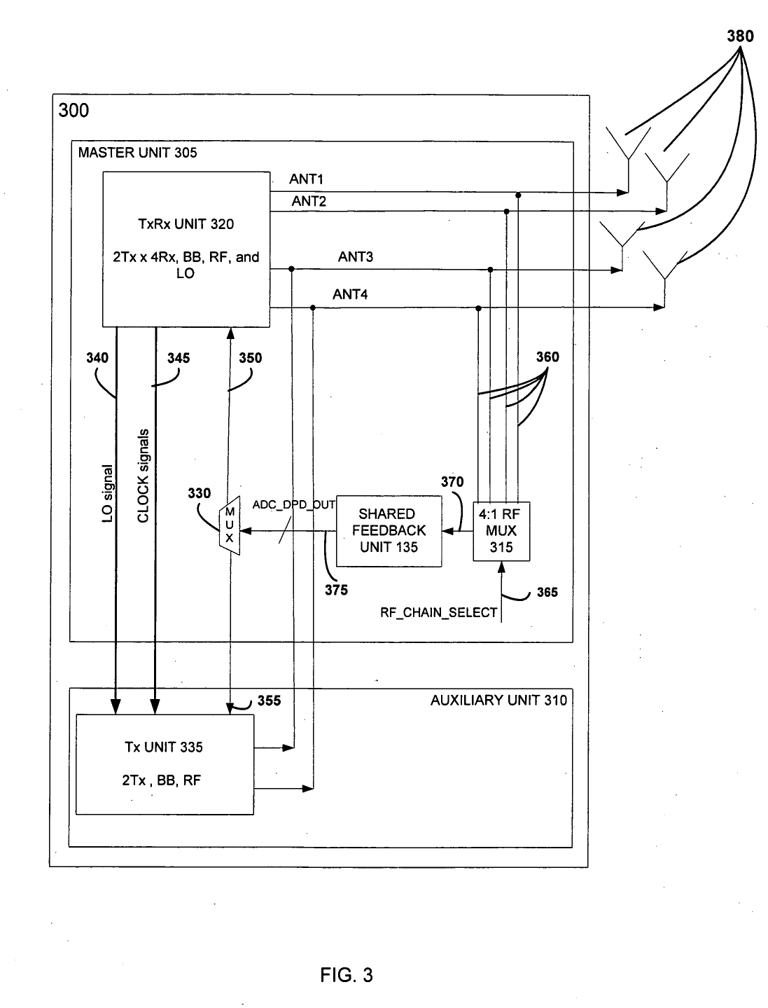

The base-band unit 105 accepts input of digital communication, and encodes the digital communication at the base-band frequency, as with be further described below with reference to FIGS. 4, 7, and 8.

The radio unit (RU) 115 converts a base-band signal to a Radio Frequency (RF) signal, outputting the RF signal to an antenna 120 at a suitable power. To perform the conversion and output, the radio unit 115 contains a digital front-end which optionally performs at least one of: a digital frequency up-conversion; a digital frequency translation to a high IF frequency; digital pre-distortion; and crest factor reduction. In a receive path the RU 115 optionally down-converts the RF signal to a base-band sampled signal after the received signal passes the receiver digital front-end section. In alternative configurations the radio unit 115 optionally handles either single or multiple transmit and receive radio chains, by way of a non-limiting example 2 or 4 transmit and receive radio chains.

The base-band to radio unit interface 110 optionally transfers data path and control information between the base-band unit 105 and the radio unit 115.

The base-band to radio unit interface 110 may optionally be an optical interface, and may be a wired, such as copper, interface. The base-band to radio unit interface 110 optionally conforms to an accepted interface standard, such as, by way of a non-limiting example, an Open Base Station Architecture Initiative (OBSAI) interface or a Common Public Radio Interface (CPRI).

The above-mentioned components of the base station 100 of FIG. 1A, in some embodiments of the invention, are optionally included in the same enclosure, while in other embodiments such as a dual-box configuration and some macro base station embodiments, the components are strictly partitioned in different enclosures.

A potential advantage of the dual-box configuration is providing the same configuration for a single-box and a remote radio-head configuration, and providing independent development and upgrade paths of each component, which optionally simplifies introduction of new radio-heads and provides flexibility for up-scaling of base stations.

Alternative embodiments of the design depicted in FIG. 1A are modular designs, enabling mixing and matching various numbers of base band units 105 with various numbers of radio units 115.

The Base-Band Unit 105

The base-band unit 105 includes the following functionality: handling one or more carrier signals, for example supporting two carrier signals; modulation/demodulation of data per carrier, to get a base-band representation for one or more transmit/receive paths; optionally handling radio resource management, such as admission control, scheduling, and frame building; optionally supporting different multi-antenna configurations and techniques, such as: 2Tx-2Rx or 2Tx-4Rx, MIMO, or diversity transmission configuration; optionally supporting 4Tx-4Rx beam-forming; and optionally supporting handling of synchronization, such as synchronization to a GPS 1pps signal.

The base-band unit 105 is optionally a source of the following: transmit and receive signals for one or more channels for one or more antennas; radio control information; and synchronization.

The following list includes a description of high level features of the base-band unit 105:

using a drive interface synchronization clock for synchronization of the base-band unit 105 to a radio unit 115;

managing communication to and from the radio unit 115 through the BB-RH interface, thereby optionally enabling the same flow for a single-enclosure configuration as for a multiple enclosure remote radio unit 115 configuration;

removing dependencies on a specific radio unit 115 implementation, thereby optionally enabling releases, changes, and upgrades to the base-band unit 105 independently of implementation, changes and upgrades to the radio unit 115, and simplifying support of multiple base station configurations;

output and input to the base-band unit 105 are at a base-band sampling rate, thereby achieving interface rate reduction and removing dependencies between the design of the radio unit 115 and the design of the base-band unit 105; and

in case of multiple carrier signal support, each carrier signal may optionally use an independent input and output stream, optionally mixed on the same BB-RH interface, thereby enabling flexibility in mapping carriers to radio units 115 and using similar radio unit 115 configurations whether two carrier signals are generated on the same base-band unit 105 or on two separate base-band units 105.

The Radio Unit 115

The radio unit 115 receives a base-band signal supplied by the base-band unit 105, optionally performs digital up-conversion, and performs conversion to RF and transmission of the RF signal.

The radio unit 115 optionally includes one or more transmit and receive chains. Each transmit chain optionally handles one or more carriers, such as, by way of a non-limiting example, two adjacent 10 MHz carriers over a 20 MHz wide radio-head. When overlaying more than one carrier on the same radio chain, the source of the carrier is optionally either the same base-band unit 105 or more than one different base-band units 105.

In order to allow for a clear cut between the radio unit 115 and the base-band unit 105, implementation of specific functionality such as RF processing optionally runs on the radio unit 115, thereby keeping the base-band to radio unit interface as generic as possible.

The following list includes a description of high level features of the radio unit 115:

management of the radio unit 115 is optionally performed by a set of general control commands and reports, which simplifies potential development of new radio units 115, and enables optional outsourcing of radio unit 115 development;

RF operations are functionally performed in the radio unit 115, removing a constraint between radio-head implementation and base-band software, and reducing effort for optional new radio-head development, both on the RH side and on the BB side;

optionally performing frequency translations from base-band to RF in the radio unit 115 results in that the interface to the base-band unit 105 is not dependent on RH implementation specifics, such as Digital High-IF versus dual conversion and simplifies carrier multiplexing (“IF-Mux”);

a flexible base-band channels to radio channels mapping provides simple generation of new RH configurations and enables optional use of redundancy;

in beam-forming configurations, calibration functionality, as described further below, supports the beam-forming functionality;

optionally having a single RF LO enables locking phase among different radio channels, whether the different radio channels are on the same transmit path card or on different transmit path cards, thereby simplifying beam-forming.

The Base-Band to Radio Unit Interface 110

The base-band to radio unit interface 110 supports the following features:

1) Digital interface to enable support of DPD and CFR implementation.

2) Support of diversified configurations including, without limiting generality:
a. Single carrier implemented with a single BB and single RU.
b. Dual carrier implemented with a single BB and single RU.
c. Dual carrier implemented with a dual BB and a single RU.
d. 4 transmit chains in a beam-forming configuration, implemented as single BB single RU, optionally with an optimized BF RU.
e. 4 transmit chains in a beam-forming configuration, implemented as single BB dual RU, with the beam-forming configuration using basic MIMO RU blocks.
f. Two carrier 4 transmit chains, in a beam-forming configuration, implemented as dual BB dual RU (beam-forming configuration using basic MIMO RU blocks)

3) Conveying synchronization signaling.

4) A transport control channel optionally using a radio control command set according to an appropriate standard.

5) Allowing transmission of base-band, control, and synchronization signals over a single optical media in a remote radio-head configuration.

6) Optional support of industry accepted standards in the remote radio-head configuration.

The above features are further included in the following list:

the base-band to radio unit interface 110 optionally supports connection of multiple BB's to multiple RU's, enabling a mapping of 2 carriers or more from two or more BB units to one transmit receive chain and/or a mapping of chains of the same carrier from one BB unit to be mapped to different RU's, and combinations of the above;

remapping of the configuration of the base-band to radio unit interface 110 described in the paragraph above enables channel remapping in case of failures, optionally using redundancy, and simple sector configuration changes, such as carrier addition;

optionally changing carrier channel signals to base-band representation (I,Q) enables simple carrier combining, interface rate reduction, conserves DPD bandwidth, and makes the interface rate independent of radio implementation;

support of OBSAI and/or Common Public Radio Interface (CPRI) in a remote RH configuration enables using off-the-shelf available hardware for producing the base-band to radio unit interface 110 and supports the above-mentioned features;

optional use of an in-band management channel enables maintaining as little as a single connection in a remote RH configuration, and optionally using the same control strategy in more than one, and/or even in all, configurations;

optional support for different base-band signal sampling frequencies enables simple adaptation to 5 Mhz, 7 Mhz, 10 Mhz, and 20 Mhz sampling clocks;

optional clock locking between the base-band unit 105 and the radio unit 115, with the base-band unit 105 optionally as a reference simplifies rate conversion and simplifies locking of the radio unit 115 to a 1PPS signal frame clock;

optional transport of calibration channel data and control signals enables calibration support; and

optional delay compensation for remote radio unit 115 configurations.

In embodiments of the invention using a single enclosure configuration, the base-band to radio unit interface 110 optionally uses the same interfacing concept and/or optionally a different electrical interface definition, such as a parallel electrical interface instead of a serial optical. The interface is optionally similar to OBSAI and/or CPRI. The optional similarity optionally enables a single design and maintenance effort for different base-band unit 105 and radio unit 115 configurations, block and module exchange between configurations, and cost reduction when used in a single-box configuration.

Specification of the Radio Unit 115

It is noted that the values specified below are optionally valid over the entire operational temperature range. The entire operational temperature range of an exemplary embodiment of the invention is −40−+85 [Deg Celsius]

It is noted that operational temperature is affected by the energy efficiency of the base station, and of components such as the radio unit 115. In order for a component to be installable outside an air conditioned enclosure, such as in case of an outdoor installation, the component should dissipate enough heat to keep within the operational temperature range. The above-mentioned reduction in component count and attendant improved energy efficiency support outdoor installation of the base station components, including the radio unit 115.

Architecture Description:

The base station 100 of FIG. 1A optionally supports a 2Tx×4Rx configuration for MIMO applications, and optionally supports 4Tx×4Rx configuration for BF, BF+Nulling, MIMO+BF and SDMA. The BF requirements impose a calibration scheme on the radio unit 115, both Tx and Rx, of the base station 100 in order to fulfill reciprocity, at a minimum, of the Tx vs. Rx transfer functions, such as

$$\frac{{H}_{Tx} ( f )}{{H}_{Rx} ( f )} ≅ 1.$$

The above BF calibration requirement applies to each BB+RF chain. A DPD algorithm and a Crest Factor reduction algorithm are also optionally introduced. The algorithms, together with a calibration algorithm, are optionally supported by a design as described below. The feedback path of the DPD optionally helps calibration. The above calibration scheme optionally enables exemplary embodiments of the invention to meet the calibration and accuracy requirements of BF+nulling, and the even tougher requirements of DL-SDMA. As will be described below, the above algorithms are implemented in a manner which also reduces power consumption and cost.

An architecture with a minimal number of Surface Acoustic Wave (SAW) filters is optionally used in order to facilitate BF calibration requirements. Optionally, a single SAW filter is used in the Rx chain, introduced for interference rejection purposes. The other filters in the transmit path, as well in the feedback path, are LC filters which optionally have low group delay and low group delay ripple. For BF calibration requirements, cost, and minimal bill of materials (BOM), a homodyne (single analog conversion) radio architecture is optionally selected.

A single LO is used and the single LO is shared between the Tx, the Rx, and the DPD-RX feedback path, to optionally eliminate phase noise calibration issues, as well as BF calibration requirements, cost, and minimal BOM.

A single feedback path is optionally shared between the four Tx antennas. Due to a relatively large BW of the radio, for an example embodiment having 110 [MHz], the power amplifier (PA) is designed for interference immunity and P1 dB (1 dB compression point) and Input IP3 (Input IP3=Input third order intercept point) characterization of the receive chain.

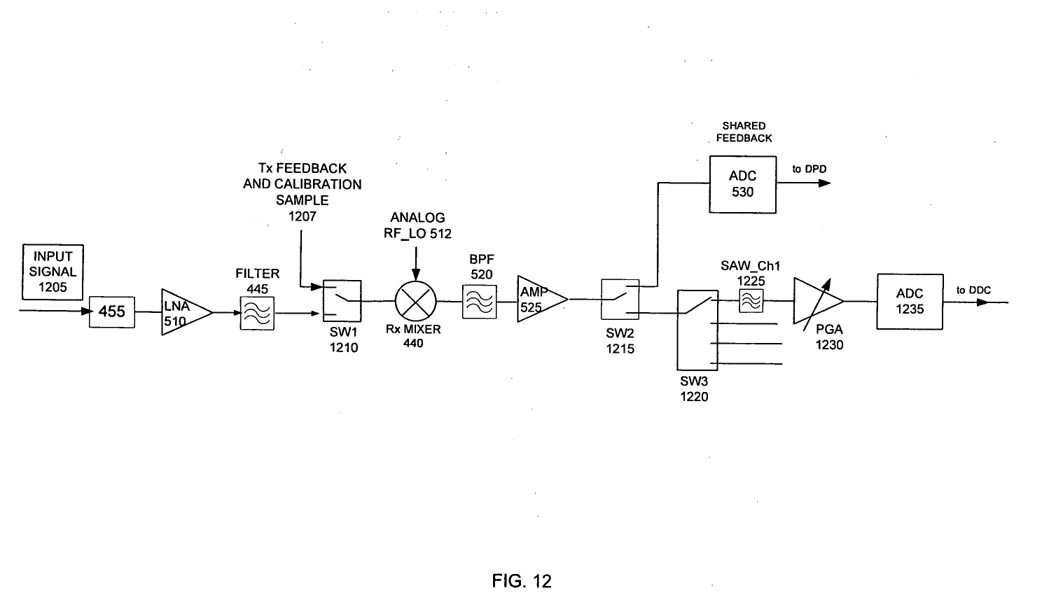

A single SAW filter feedback path is optionally shared between the four Tx paths, as will be described further below, with reference to FIG. 12.

Co-existence with neighboring frequency cellular technologies is also optionally handled.

To summarize, the architecture and the radio design, as well as the base-band digital front-end design of the invention, minimize the number of components and power consumption, while meeting interference rejection requirements, noise figure (NF) requirements, BF+nulling requirements, and DL-SDMA requirements.

Description of a shared feedback path in a MIMO base station (BS) Reference is now made to FIG. 1B, which is a simplified block diagram of a shared feedback unit in an exemplary embodiment of the base station 100 of FIG. 1A.

The base station 100 includes the base band unit 100 of FIG. 1A, and the radio unit 115 of FIG. 1A, connected by the base-band to radio unit interface 110 of FIG. 1A.

The base band unit 105 accepts input of digital data 125, and prepares the digital data for wireless communication. The digital data is optionally converted to a base band frequency signal, and transferred to the radio unit 115 via the base-band to radio unit interface 110. Within the radio unit 115 the digital data passes through a Digital Pre-Distortion (DPD) unit 130.

The DPD unit 130 optionally performs digital pre-distortion based on an input signal 132 which includes pre-distortion coefficients, which comes from a shared feedback unit 135, and which is further described below.

The DPD unit 130 sends transmit signals via one or more transmit paths 140, for example, and without limiting generality, four transmit paths 140. In other embodiments, 2, 3, 5, 6, 10 or other number of paths are used. The transmit paths are described in more detail below, with reference to FIG. 4. Outputs of the transmit paths 140 pass through transmit/receive separators 455, and are provided to antennas 120 for transmission. The transmit paths, up to the antennas 120, will be described in more detail below with reference to FIG. 4.

It is noted that the components depicted as the transmit/receive separators 455 optionally also include a band pass filter. The transmit/receive separator may be a circulator, the transmit/receive separator may be a switch, and the transmit/receive separator may be other devices used for separating between an outgoing RF signal and an incoming RF signal.

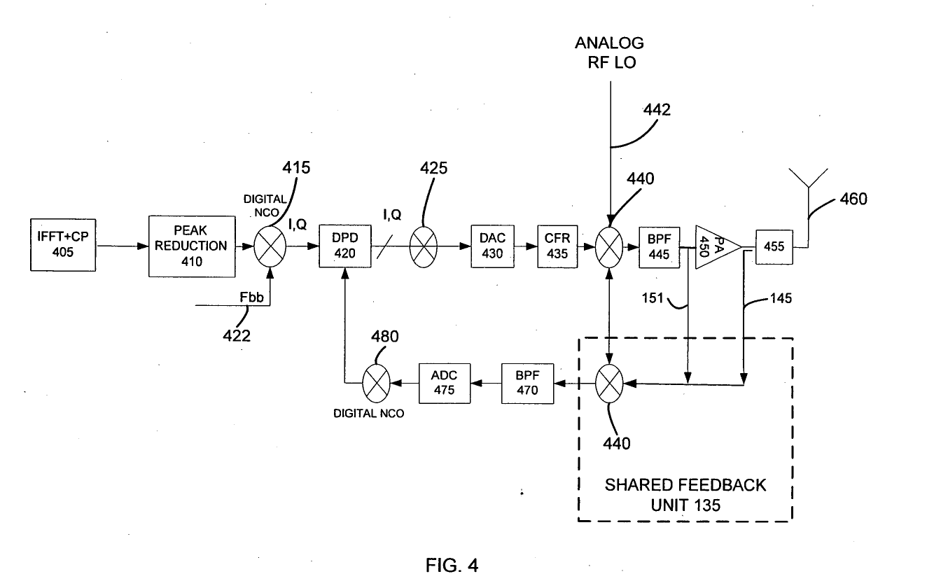

The antennas 120 also provide input back to the transmit/receive separators 455, and to one or more receive paths 142. Without limiting generality, four receive paths 142 are depicted. In other embodiments, 2, 3, 5, 6, 10 or other number of paths are used. The receive paths 142 are described in more detail below, with reference to FIG. 5A.

The outputs of the transmit paths 140 are optionally picked up at two points between the transmit paths 140 and the antennas 120, and provided to the shared feedback unit 135.

A first set of couplers 145 for some and/or all transmit paths 140 optionally picks up the outputs before the transmit/receive separators 455, and optionally passes the outputs, to the shared feedback unit 135.

A second set of couplers 150 optionally picks up the output signals after the transmit/receive separators 455, picking up the signals as they go to the antennas 120, and optionally pass the picked up signals to the shared feedback unit 135.

The outputs picked up by the sets of couplers 145 150, being of full power, optionally pass through an attenuator (not shown) and are also converted from RF back to base-band or an intermediate frequency by an RF mixer (not shown).

The shared feedback unit 135 is further described below, with reference to FIGS. 5B, 5C, 5D, and 5E.

In some embodiments of the invention there is only one set of couplers 150, which provides the picked up signal to the shared feedback unit 135, to be used both for the purposes described below with reference to the couplers 150, and for the purposes described below with reference to the couplers 145.

As will be detailed further below with reference to a section named “The Calibration Process”, transfer functions of the receive paths 142 are measured using one transmit path 140. A path 151 is optionally provided from one of the transmit paths 140, before power amplification of the transmit path 140, to the shared feedback unit 135. The shared feedback unit 135 optionally sends the non-power-amplified signal received via the path 151 through a path 153 to the couplers 150. The couplers 150 feed the signal to the antennas 120, from which the signal is optionally received by the receive paths 142.

The path 151 is depicted as coming from the first transmit path Tx1 140. It is noted that the path 151 may be connected to any one of the transmit paths 140, before power amplification.

In some embodiments of the invention a rudimentary, or degenerate, transmit path may be used to supply a signal to the path 151. The rudimentary transmit path is equivalent to a normal transmit path 140, such as described in more detail with reference to FIG. 4, without including a power amplifier.

As will also be detailed further below with reference to the section named “The Calibration Process”, transfer functions of transmit paths 140 are measured using one receive path 142. A path 152 from the shared feedback unit 135 to a suitable point within one of the receive paths 142 is provided, for the above-mentioned measurement.

The shared feedback unit 135 routes signals for transmit and receive path calibrations, for beam forming, and for digital pre-distortion.

For digital pre-distortion, output from a coupler 145 on a transmit path 140 is optionally sent by the shared feedback unit 135 to the base band unit 105, via the base-band to radio unit interface 110. The base band unit 105 optionally uses a Digital Signal Processor (DSP) (not shown) which optionally calculates an array of digital pre-distortion coefficients, and transmits the coefficients to the DPD unit 130. The array of digital pre-distortion coefficients is optionally a one dimensional array optionally including a digital pre-distortion coefficient for each antenna.

For beam forming, also termed antenna calibration, output from a coupler 150 is optionally sent back to the base band unit 105, via the base-band to radio unit interface 110. The base band unit 105 optionally uses a Digital Signal Processor (DSP) (not shown) to calculates a matrix of beam forming coefficients, used to multiply transmitted signals in a transmission path. The matrix of beam forming coefficients is optionally a two dimensional matrix optionally including values for each antenna and for each carrier frequency.

In order for the output from the coupler 150 to be suitable for transmission via the base-band to radio unit interface 110, the output optionally passes through one of the receive paths 142. In an exemplary embodiment of the invention, the shared feedback unit 135 shares one or more components with one of the transmit paths 142.

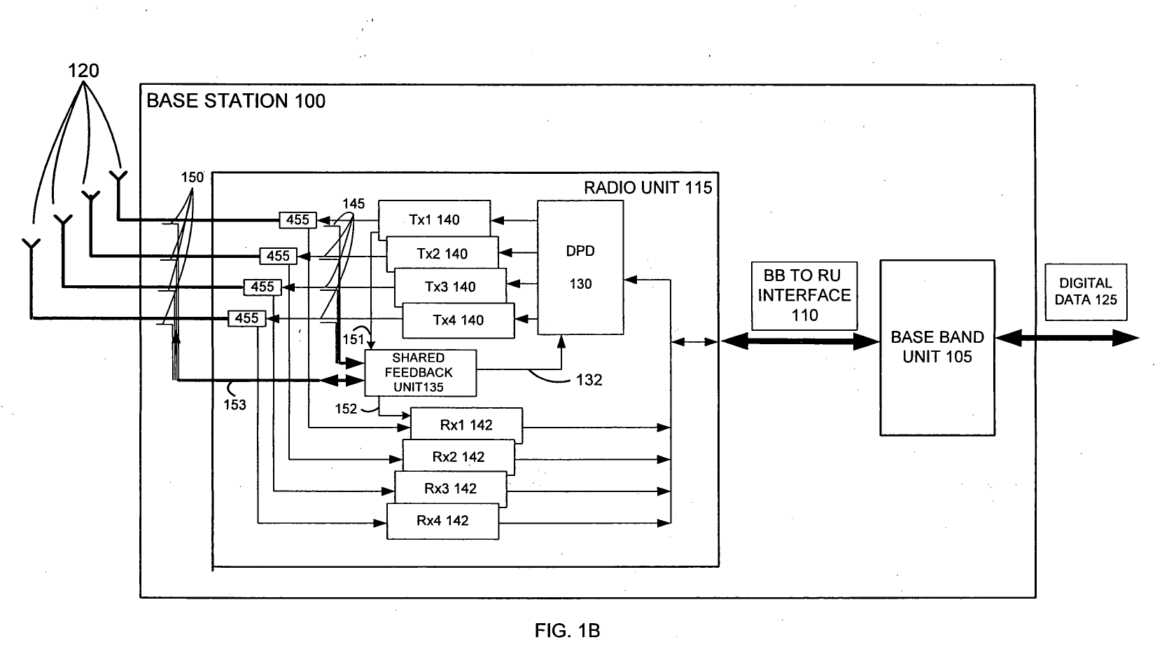

Reference is now made to FIG. 2, which is a simplified block diagram of a shared feedback path in an exemplary single enclosure MIMO base station 200 embodiment of the base station 100 of FIG. 1A.

The MIMO base station 200 includes a TxRx unit 205 including two full transmission (Tx) chains (BB+RF) and four full reception (Rx) chains (BB+RF), a 2:1 RF MUX 210, and a shared feedback unit 135. The MIMO base station 200 is operatively connected to antennas 217. It is noted that in FIG. 2, only two Tx chain antennas 217 are depicted, additional antennas may be provided and are not currently depicted.

The MIMO base station 200 includes one shared feedback unit 135, which is shared between two antennas (not shown). The synthesizers for the two Tx and four Rx antennas are located within the MIMO base station 200 enclosure.

The TxRx unit 205 outputs two Tx path outputs 220 225, at Radio Frequency (RF), into the antennas 217. The 2:1 RF MUX 210 is connected to the outputs 220 225 leading to the antennas 217. An RF_CHAIN_SELECT signal 230 instructs the 2:1 RF MUX 210 which of the two outputs 220 225 to output to the TxRx unit 205, using round-robin techniques in which at each time a different antenna 217 is selected by the 2:1 RF MUX 210.

The 2:1 RF MUX 210 optionally outputs a signal 235 to the feedback unit 215, which optionally outputs a signal ADC_DPD_OUT 240 to the TxRx unit 205 for the purpose of adaptive pre-distortion.

It is noted that the TxRx unit 205 includes four digital oscillators (not shown) each of which is optionally at a selected carrier frequency. The TxRx unit 205 also includes four TDD switches (not shown), four circulators (not shown), and four 110 MHz cavity filters (not shown).

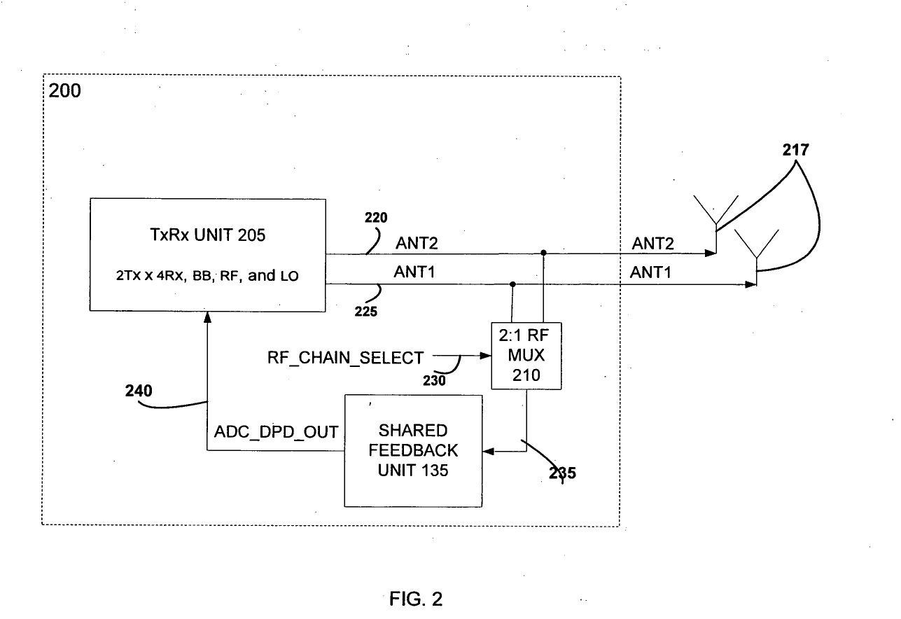

Reference is now made to FIG. 3, which is a more detailed simplified block diagram of a shared feedback path in an alternative embodiment of the base station 200 of FIG. 2.

FIG. 3 depicts a single enclosure MIMO+BF BS base station 300 configuration, which includes two sub units: a master unit 305 and an auxiliary unit 310, inside the single enclosure.

The master unit 305 is based on a basic 2Tx×4Rx unit. The master unit 305 includes a TxRx unit 320 which provides functionality similar to the TxRx unit 205 of FIG. 2, a 4:1 RF Mux 315, a shared feedback unit 135, and a Mux unit 330.

The auxiliary unit 310 includes an additional Tx unit 335 with two full (BB+RF) chains.

Together the main unit 305 and the auxiliary unit 310 make up a 4Tx×4Rx BS, and also a calibration port for calibration purposes.

Operation of the base station 300 will now be briefly described.

The TxRx unit 320 and the additional Tx unit 335 are operatively connected to produce Tx signals, which are provided to antennas 380.

The TxRx unit 320 of the master unit 305 optionally provides some and/or all the required clocks, DAC, ADC, IF, DPD, system clock, and synthesizer reference clock, optionally for some and/or all four Tx and Rx chains of the master unit 305 and the auxiliary unit 310. The clock signals are depicted as transferred from the TxRx unit 320 of the master unit 305 to the additional Tx unit 335 of the auxiliary unit 310 via a single clock signal line 345, although it is appreciated that the clock signal line optionally transfers some and/or all the clock signals using as many operative connections as needed.

An RF LO signal is transferred from the TxRx unit 320 of the master unit 305 to the additional Tx unit 335 of the auxiliary unit 310 via an LO signal line 340.

Incoming signals from the antennas 380 are provided back along Rx paths to the TxRx unit 320. Additionally, the incoming signals are provided via feedback paths 360 to the 4:1 RF Mux 315. An RF CHAIN_SELECT signal 365 instructs the 4:1 RF Mux 315 to select an incoming signal and produce a TDD RF output signal similarly to the description above made with reference to FIG. 2.

On a receiving (Rx) path, the 4:1 RF Mux 315 provides a feedback signal 370 of one of the Tx signals to the shared feedback path. The feedback signal 370 is input to the shared feedback unit 135, which manages calculation of a digital feedback signal 375 and outputs the digital feedback signal 37. The digital feedback signal 375 passes through a the Mux unit 330, which sends the digital feedback signal 375 either to the TxRx unit 320 via an operative connection 350, or to the additional Tx unit 335 via an operative connection 355.

It is noted that the feedback unit 135 optionally manages calculation of the digital feedback signal 375 by communicating with a DSP, as described above with reference to FIG. 1B.

The base station 300 has a single feedback path, which is shared, by time division, between the four Tx antennas. Adaptation of a transmit chain is done using the 4:1 RF-MUX 315 comprised in the master unit 305. Hence, from temperature stability and from aging aspects, which can be important for DL-SDMA calibration purposes, the four Tx chains see the same feedback path and the same hardware, and are thus aligned. Since there is a single DPD feedback path with a single analog LC filter, some, and/or all, Tx chains are matched in terms of gain and phase to this shared feedback path.

It is noted that temperature and aging phenomena of transmitters are relatively slow processes, therefore differential stability and matching between some, and/or all, the Tx chains is maintained even though the Tx paths use the DPD paths at slightly different times.

The architecture of the base station 300 includes a single RF LO (not shown), which is shared between all Tx chains and between all Rx chains, and between the Tx and the Rx. Moreover, the same RF LO is used in optionally implementing pre-distortion, since the same RF LO is shared between the Tx path and the shared feedback path.

Alternative embodiments of the invention share an RF LO between all Tx chains and the shared feedback path and another different RF LO between all RX chains.

Yet other alternative embodiments of the invention share the RF LO between only some of the Tx chains and/or some of the Rx chains.

Introducing a single LO for both Tx and DPD-Rx chains corrects for phase noise instability and mismatch due to RF oscillators (not shown), and makes phase noise variations negligible with regard to the pre-distortion algorithm.

The pre-distortion algorithm is optionally an algorithm which corrects gain and phase of non-linearity in the base-band frequency of the Tx path.

Optionally, the architecture of the base station 300 is scalable. Additional auxiliary units 310 can be added to the base station 300, appropriately connected to antennas 380, clock signals 345, LO signals 340, and the operative connections 355 to the feedback path.

Alternative embodiments of the design depicted in FIG. 3 are modular, enabling mixing and matching various numbers of one or more master units 305 with various numbers of auxiliary units 115.

Alternative embodiments of the design depicted in FIG. 3 have different numbers of Tx and Rx units in the master unit 305, and different numbers of optional Tx units and optional Rx units in the auxiliary unit 310. By way of a non-limiting example, there may be 0, 1, 2 3, 4, 5 or more Tx units in the master unit 305, there may be 0, 1, 2, 3, 4, 5 or more Rx units in the master unit 305, there may be 1, 2, 3, 4, 5, and more auxiliary units 310 in the base station 300, there may be 0, 1, 2, 3, 4, 5 or more Tx units in the auxiliary unit 310, and there may be 0, 1, 2, 3, 4, 5 or more Rx units in the auxiliary unit 310.

It is noted that using one master unit 305 with several auxiliary units 115 is particularly efficient, having one set of clock signal sources and oscillators for a number of auxiliary units 115.

Detailed Architecture Description

The radio architecture used in the base stations of the above mentioned embodiments is optionally a single conversion scheme, in which there is optionally a single local-oscillator (LO), and sampling in both a DPD feedback path and in a regular Rx path is done in IF frequency.

Transmitter Side Architecture

Reference is now made to FIG. 4, which is a simplified block diagram of a transmission (Tx) path of an exemplary embodiment of the base station of FIG. 1A.

FIG. 4 depicts both a forward Tx path and a feedback path, although the feedback path is actually shared between a number of Tx paths.

The Tx path is as follows:

An incoming digital communication signal passes through an Inverse FFT (IFFT) and Cyclic Prefix (CP) addition unit 405. An output of the IFFT and CP passes through a peak reduction unit 410. An output of the peak reduction unit 410 is passed to a digital Numerically Controlled Oscillator (NCO) 415 which is acting as a signal mixer, and which also receives an input 422 of a base-band frequency Fbb. An output of the NCO 415 is fed into a Digital Pre Distortion (DPD) unit 420. The pre-distorted signal optionally passes through an additional digital NCO 425, which optionally digitally raises the signal frequency to an intermediate frequency. The resulting, optionally Intermediate Frequency (IF) signal, is converted to an analog signal by a Digital to Analog Converter (DAC) 430. The resulting analog signal passed through a Crest Factor Reduction (CFR) unit 435. The output of the CFR unit 435 is fed to a mixer 440, and mixed with an analog RF LO signal 442, producing an RF signal carrying the input signal.

It is noted that the RF LO signal 442 is optionally shared by more than one forward Tx paths, and by optionally more than one feedback paths.

After the mixer 440, the RF signal passes through a Band Pass Filter (BPF) 445. The filtered signal passes through a Power Amplifier 450, and an additional transmit/receive separator 455, and is fed to an antenna 460.

The output of the BPF 445 optionally also provides output to the shared feedback unit 135 of FIG. 1B by the path 151 (also depicted in FIG. 1B).

The output of the Power Amplifier 450 optionally also provides output to the shared feedback unit 135 of FIG. 1B through the coupler 145 (also depicted in FIG. 1B).

It is noted that the transmit/receive separators 455 optionally also includes a band pass filter, as described above with reference to FIG. 1B.

Optionally, the BPF 445 is a ceramic filter, used for spurious signal rejection.

The feedback path is as follows:

A signal provided through the coupler 145 or the path 151 is optionally provided to the shared feedback unit 135. Within the shared feedback unit 135 the signal is fed to the mixer 440. How a signal is optionally selected from the coupler 145 or the path 151 and optionally provided to the shared feedback unit 135 is further described below, with reference to FIGS. 5B, 5C, 5D, and 5E.

It is noted that, for purpose of clarifying the feedback path, the mixer 440 in the feedback path is depicted separately from the mixer 440 in the Tx path. Optionally, mixer 440 may be shared between the Tx path and the feedback path, and there is just one mixer 440. The mixer 440 is optionally shared between the Tx path and the feedback path at the same time, using reversed polarity.

The output of the mixer 440 in the feedback path, which is optionally an intermediate frequency (IF) analog signal, is fed through a BPF 470. The output of the BPF 470 is fed to an Analog to Digital Converter (ADC) 475. The ADC 475 performs IF sampling, and outputs a digital signal. The digital signal is fed to a digital NCO 480, optionally producing a digital signal at base-band frequency.

The DPD 420 expansion BW is optionally approximately seven times a signal channel bandwidth. The DPD and CFR modules optionally work at a sampling frequency of approximately 130 [MHz]. The feedback path sampling frequency is optionally approximately 260 [MHz]. As described before, the same mixer 440 is used for both the forward path and the feedback path. The IF frequency, which is optionally used, is approximately 200 [MHz].

The digital NCO 480 in the feedback path is used to translate the signal in the feedback path to DC. The BPF 445 in the forward path between the mixer 440 and the PA 450 is optionally used to eliminate spurious emissions due to the mixer 440.

The transmit/receive separator 455 before the antenna optionally includes a cavity filter whose width is greater than 100 [MHz]. Analog sampling, using a directional coupler and a splitter for the DPD feedback path optionally happens before the transmit/receive separator 455.

Small frequency corrections, if needed, are optionally applied after the CFR 435 module and optionally also before the DPD 420, optionally using the NCO 415. In such a case a feedback signal in the DPD path is aligned to the transmitted signal, and no extra frequency correction is needed.

It is noted that all filters in the above description are optionally LC filters, having low group delay. The group delay ripple of the filters in the example embodiment described herein is optionally bounded to 5-6 [ns], and optionally even less.

It is to be appreciated that the units of FIG. 4 which operate on signals in the digital domain, that is, the units on the left, optionally up to and including of the DAC 430, and up to the ADC 475, are optionally included in a single integrated circuit (IC). Inclusion in a single IC provides one or more of the following advantages: simplification of the bill of materials of the base station, enhanced reliability, and manufacturability.

Receiver Side Architecture

Reference is now made to FIG. 5A, which is a simplified block diagram of a reception (Rx) path of an exemplary embodiment of the base station of FIG. 1A.

FIG. 5A depicts a simplified block diagram of a high IF single conversion receiver. An RF signal is received by an antenna 460. The received signal passes through a transmit/receive separator 455, which optionally includes a band pass filter (not shown). The signal then passes through a Low Noise Amplifier (LNA) 510. The amplified signal then passes through an optional additional filter 511. The additional filter 511 is an RF image rejection filter.

The amplified and filtered signal is then mixed by a mixer 440, which is the same mixer 440 of FIG. 4, with a RF LO signal 512 from the shared analog RF LO.

The mixed signal passes through an analog BPF 520. The analog BPF 520 performs replica selection on the signal, thereby extracting a lower frequency signal. The lower frequency signal is optionally an IF signal.

The output of the BPF 520 is passed through a Programmable Gain Amplifier (PGA) 525.

The optionally amplified signal is output to an Analog to Digital Converter (ADC) 530. The ADC 530 optionally performs sampling at some IF frequency, providing an output of a digital signal sampled at the IF frequency. The output of the ADC 530 is mixed by a mixer 535 with a base-band frequency signal Fbb 542.

The output of the mixer 535 is provided to a modem 540 which produces the signal which was received by the base station as a signal appropriate for the base station's client. By way of a non-limiting example, the output of the modem 540 is a signal according to the Ethernet protocol.

The modem 540 also provides a control signal 545 to the PGA 525, controlling the amplification of the PGA 525.

It is noted that the ADC 530 samples an incoming (real signal) which passes the analog BPF 520, whose BW is matched to channel BW, at an IF frequency. The analog BPF 520 is optionally an RF SAW filter. The filtered signal is digitally down-converted to DC and decimated.

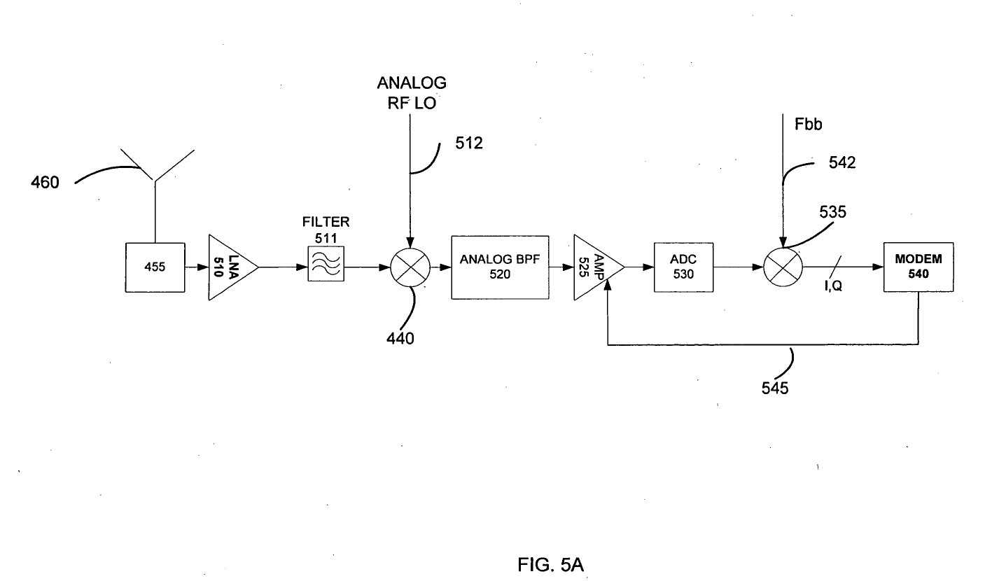

The analog BPF 520 selects a required replica which is optionally located in the third Nyquist zone, and which is centered on F_{IF} as is described below with reference to FIG. 6. It is noted that the sampling frequency of the ADC 530 is optionally selected such that

$${F}_{S , RX} = \frac{4}{5} {F}_{IF} .$$

It is noted that the transmit/receive separator 455 corresponds to the transmit/receive separator 455 of FIGS. 1B and 4. It is noted that the transmit/receive separator 455 optionally also includes a band pass filter, as described above with reference to FIG. 1B.

It is noted that after a digital down-conversion performed by the mixer 535, a power meter (not shown) is introduced. The digital power meter sums, or averages, received input signal power based on

$${\sum }_{k} {I}_{k}^{2} + {Q}_{k}^{2} ,$$

where K is the base-band frequency sample index. The power meter is introduced in order to set the control signal 545. Based on the power measurements, an Automatic Gain Control (AGC) sets a value of the PGA 525 gain.

Reference is now made to FIG. 5B, which is a simplified block diagram of a shared feedback unit 135 in an exemplary embodiment of the base station of FIG. 1A.

In an exemplary embodiment of the invention, the shared feedback unit 135 receives inputs from the couplers 145 of FIG. 1B.

FIG. 5B depicts a plurality of inputs from the couplers 150, in the alternative embodiment of the invention mentioned above with reference to FIG. 1B, in which the couplers 150 pick up output signals which serve both for the purpose described with reference to output signals of the couplers 150, and for the purpose described with reference to output signals of the couplers 145.

The inputs from the couplers 150 are fed into a mux 550, which optionally selects one of the inputs at a time, by time division multiplexing.

A single output 551 is provided from the mux 550, into a switch 1325. The switch 1325 optionally accepts input through a path 151 also depicted in FIG. 1B. The switch selects one of the two inputs for providing as a signal to an attenuator 552, which optionally attenuates the signal and provides the signal to a Band Pass Filter (BPF) 554. The BPF 554 optionally provides output to a controlled attenuator 556, which provides output to a mixer 440 (also depicted in FIG. 4). The mixer 440 mixes the output provided by the controlled attenuator 556 with an analog RF LO signal 442 (also FIG. 4). Output of the mixer 440 is optionally at an Intermediate Frequency (IF), while input to the mixer 440 is at RF.

Output of the mixer 440 is optionally provided to a Low Pass Filter (LPF) 558, which provides its output to an Intermediate Frequency (IF) amplifier 560. The IF amplifier 560 provides its output to a switch 562, which optionally provides output either as the signal 132 of FIG. 1B or as a signal through the path 152 of FIG. 1B.

In some embodiments of the invention, the shared feedback unit 135 shares some components with a receive path.

Reference is now additionally made to FIG. 5C, which is a simplified block diagram of an alternative exemplary embodiment 571 of the shared feedback unit in an exemplary embodiment of base station of FIG. 1A, showing shared components with an exemplary receive (Rx) path.

The alternative embodiment 571 of a shared feedback unit comprises the mux 550, the switch 1325 the attenuator 552, the BPF 554, the controlled attenuator 556, the mixer 440 (also depicted in FIG. 4), the LPF 558, the IF amplifier 560 and the switch 562, which are also depicted in FIG. 5B.

The mixer 440 (also depicted in FIG. 4), the LPF 558, the IF amplifier 560 and the switch 562, are shared with a receive path.

The signal flow through the alternative embodiment 571 of the shared feedback unit follows the description provided for the signal flow provided above with reference to the shared feedback unit 135 of FIG. 5B.

A switch 566 is added to the alternative embodiment 571 of the shared feedback unit relative to the shared feedback unit 135 of FIG. 5B, and may serve to optionally accept input from an RF receive (Rx) path 564 and the controlled attenuator 556. The switch 566 optionally provides output of either a signal from the lo controlled attenuator 556 or a signal from the RF Rx path 564 to the mixer 440, which is described above with reference to FIG. 5B. A section 572 which includes the switch 566 and components downstream of the switch 566 up to a switch 562, also depicted in FIG. 5B, are common to the alternative embodiment 571 of the shared feedback unit.

The switch 56z optionally provides output either as the signal 132 of FIG. 1B or as a signal through the path 152 of FIG. 1B. It is noted that when the section 572 is functioning as part of a receive path, the output of the switch 562 is provided through the path 152 to a suitable point in a receive path, such as described above with reference to FIG. 1B.

Reference is now additionally made to FIG. 5D, which is a simplified block diagram of another alternative exemplary embodiment 591 of the shared feedback unit in an exemplary embodiment of the base station of FIG. 1A.

The alternative embodiment 591 of the shared feedback unit comprises the mux 550, the switch 1325 the attenuator 552, the BPF 554, the controlled attenuator 25 556, the mixer 440 (also depicted in FIG. 4), the LPF 558, the IF amplifier 560 and the switch 562, which are also depicted in FIG. 5B.

The signal flow through the alternative embodiment 571 of the shared feedback unit follows the description provided for the signal flow of inputs from the couplers 150 (FIG. 1B), described above with reference to the shared feedback unit 135 of FIG. 5B.

A switch 580 is added to the alternative embodiment 591, relative to the configuration of the shared feedback unit 135 (FIG. 5B). The switch 580 accepts one or more inputs from the couplers 145 (FIG. 1B). It is noted that the alternative embodiment 591 therefore conforms to a configuration in which the couplers 145 (FIG. 1B) are separate from the couplers 150 (FIG. 1B).

The switch 580 optionally selects one of the one or more inputs from the couplers 145, and provides a single output 581 to an attenuator 582, which optionally attenuates the signal. The attenuator 582 provides a signal to a switch 583.

The switch 583 also optionally accepts a signal from the attenuator 552, along a path which routes signals from the couplers 150 (FIG. 1B).

The switch 583 optionally selects an input signal from the path which routes signals from the couplers 150 or an input signal from the attenuator 582, which routes signals from the couplers 145, and optionally provides output to the BPF 554. Signal flow from the BPF 554 is as described above with reference to FIG. 5B.

Reference is now additionally made to FIG. 5E, which is a simplified block diagram of yet another alternative exemplary embodiment 592 of the shared feedback unit in an exemplary embodiment of the base station of FIG. 1A, showing shared components with an exemplary receive (Rx) path.

The alternative embodiment 592 of the shared feedback unit comprises the mux 550, the switch 1325 the attenuator 552, the switch 583, the switch 580, the attenuator 582, the BPF 554, the controlled attenuator 556, the mixer 440 (also depicted in FIG. 4), the LPF 558, the IF amplifier 560 and the switch 562, which are also depicted in FIG. 5D.

The mixer 440 (also depicted in FIG. 4), the LPF 558, the IF amplifier 560 and the switch 562, are shared with a receive path.

The signal flow through the alternative embodiment 592 of the shared feedback unit follows the description provided for the signal flow provided above with reference to the alternative embodiment 591 of the shared feedback unit of FIG. 5D.

A switch 566 is added to the alternative embodiment 592 of the shared feedback unit relative to the alternative embodiment 591 of the shared feedback unit of FIG. 5D, and may serve to optionally accept input from an RF receive (Rx) path 564, and eventually provide outputs as the signal 132 of FIG. 1B or as the signal through the path 152 of FIG. 1B, as described above with reference to the alternative embodiment 571 of the shared feedback unit of FIG. 5C.

Reference is now made to FIG. 6, which is a simplified graphic description of selection of a required signal replica in the receive path (Rx) of FIG. 5A.

The horizontal direction of the graph of FIG. 6 depicts frequency, increasing from left to right.

Four Nyquist zones 605, 610, 615, 620 are depicted, distributed around a frequency Fs 625. The frequency Fs is the receiving path (Rx) frequency.

The ADC 530 of FIG. 5A functions in a Rx path, which is typically an interference environment. The dynamic range and Effective Number Of Bits (ENOB) are therefore optionally higher than those of the ADC 475 of FIG. 4, which functions in the feedback path.

Connectivity between BB and RF Units

Each Tx/Rx chain is composed of a BB unit which performs digital Tx/Rx operations which end/begin with an IFFT/FFT. The digital Tx/Rx operations include, by way of a non-limiting example, interfacing to a MAC layer, encoding, decoding, scrambling, descrambling, permutations, de-permutations, and so on.

Functionality of the base station is optionally partitioned between a base band (BB) unit and a radio unit (RU). The partition is such that, by way of a non-limiting example, in a Tx chain, the BB unit transfers, at a BB frequency, interleaved I, Q data and a clock signal+strobe signal through an interface to the RU. The RU, after recovering the BB frequency clock rate, performs interpolations, digital up conversions, CFR, and DPD.

By way of a non-limiting example, for a 10 [MHz] channel, the BB rate is optionally 11.2 [MHz]. After DPD, data is up-converted, using an NCO, to IF frequency. By way of the same non-limiting example, the IF frequency is approximately 200 [MHz]. After the up-conversion, data is passed to DACs, and to an RF section of the chain. It is noted that there are optionally two DACs, one each for I and Q channels.

The opposite occurs in an Rx path in the demodulation process. Reference is now further made to FIG. 1A, which depicts a high level schematic diagram of connectivity between the BB unit and the radio unit. The interface contains a Tx side which is optionally a part of a BB unit card. The Tx side performs packing I, Q data, optionally to OBSAI or CPRI frames, and other higher layer operations.

It is noted that although the current design optionally supports OBSAI, CPRI is also optionally supported. CPRI line rate is 614.4 [MHz]. The CPRI line rate can optionally be derived from a basic 768 [MHz] clock by dividing it by 5/4. Therefore, the change of line rate provides flexibility in interface selection.

In case of a Macro BS, or in a case where the radio unit and the BB unit are separated, such as when the BB unit is located in a room and the radio unit is installed on an antenna mast, the interface is optionally OBSAI or CPRI via a transceiver such as an optical transceiver. In an outdoor configuration, the interface can be a backplane or an equivalent media that functions as an “OBSA-like” interface. In such a case the same functionality and the same architecture are maintained while the optical transceiver is not required.

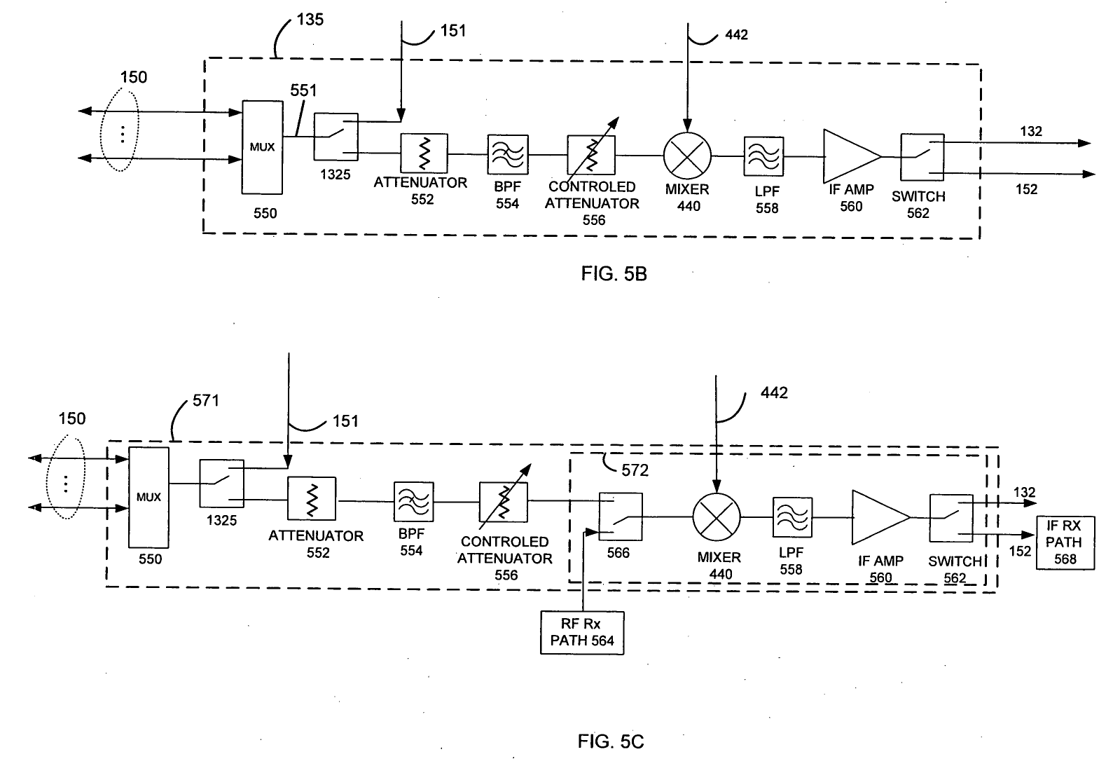

If a serial optical interface is used, such as in case of Macro BS, parallel data in a transmit side is optionally serialized using a Serializer/Deserializer (SERDES). In such a case a matching SERDES is located at a receiving side. In the case of an outdoor BS, where a BB unit card and a radio unit card are −20−30 [cm] apart, the interface is optionally implemented using a 10 [bit] parallel interface which transfers data at a rate of 76.8 [MHz] for OBSAI, or 61.44 [MHz] for CPRI. The Rx interface side is located at the radio unit card. The radio unit card decodes the OBSAI or CPRI interface packets as shown below with reference to FIG. 7, and extracts the BB clock rate. After that, I, Q information is transferred to the digital interpolation module.

Reference is now made to FIG. 7, which is a simplified diagram of a principle of operation of the base-band to radio unit interface of the base station 100 of FIG. 1A.

Serialized data 700 of a digital communication signal is received at a PHY Rx 705 layer of the base-band unit 105 of the base station 100. The base station 100 optionally performs 8 b/10 b decoding 710 of the serialized data, and passes the decoded data to a data link layer 715. The data link layer 715 passes the data to higher transport and application layers 720 of the base station 100.

The transport and application layers 720 of the base-band unit 105 transmit the data to data transport and application layers 730 of a radio unit 115, which passes the data to a data link layer 735 of the radio unit 115. The data link layer 735 passes the data to an 8 b/10 b encoder 740, which optionally performs 8 b/10 b encoding of the data. The encoded data is passed to a PHY Tx 745 layer of the radio unit 115, which outputs the data as serialized data 750.

The transport and application layers 720 730 of the base-band unit 105 and the radio unit 115 of the base station 100 optionally implement the OBSAI interface. An alternative embodiment optionally implements the CPRI interface.

The maximal line rate of the interface, optionally achieved for a 20 [MHz] channel, is, by way of a non-limiting example, 16 [bit]*22.4 [MHz]*2=716.8 [Msps/sec]. Accounting for the 8 b/10 b code used in either OBSAI or CPRI interfaces, the maximal gross line rate of the example is 896 [Msps/sec]. In case of an OBSAI interface, the BB data is sent through the digital interface at a clock rate of 76.8 [MHz]. At the OBSAI receive side a 10 bit word is decoded to 8 bits, such that a raw information unit is a byte.

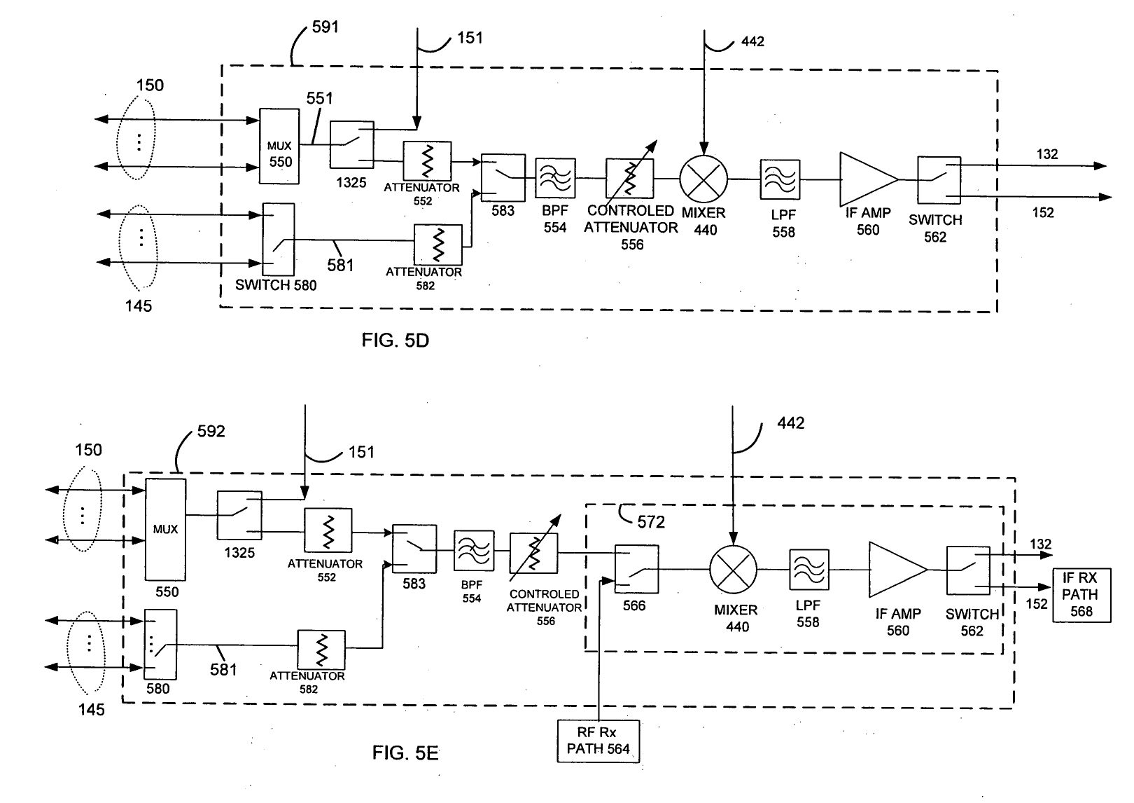

Reference is now made to FIG. 8, which is a simplified diagram of high level connectivity of a single chain base-band unit and radio unit in the base station 100 of FIG. 1A.

FIG. 8 and the description thereof provide more detail on the base-band to radio unit interface 110 of FIG. 1A.

The base-band unit 105 of FIG. 1A accepts input (not shown) of digital communication data, and is operatively connected to and uses an OBSAI compliant transceiver 805, to send an encoded version of the digital communication data over an OBSAI compliant interface 810.

The radio unit 115 of FIG. 1A is operatively connected to an OBSAI compliant transceiver 815. The OBSAI compliant transceiver 815 passes data to the radio unit 115 via an optional interpolation section 820. The interpolation section 820 is operatively connected to the OBSAI compliant transceiver 815 and to the radio unit 115.

It is noted that the OBSAI interface 810 optionally transfers data packed as data frames, and coded 8 b/10 b. The OBSAI interface 810 is uni-directional, however, data is optionally passed over the OBSAI interface 810 from the base-band unit 105 to the radio unit 115 and vice versa, using TDD.

It is noted that in the example embodiment of FIG. 8, interpolations and decimations are optionally performed at the side of the radio unit 115.

It is noted that the OBSA interface 810 can optionally multiplex several base-band units, or cards. By way of a non-limiting example, the OBSAI interface 810 can multiplex two or four base-band cards, depending on a chosen configuration. The radio unit 115 de-multiplexes a received multiplexed signal, and distributes the signal to appropriate Tx chains.

It is noted that clocks are generated at the radio unit 115, including a DAC clock, an ADC clock and a RF synthesizer reference clock. Optionally, one central clocking unit provides the above clocks.

The base-band frequency is optionally generated using digital methods.

It is noted that the OBSAI interface frequency is 768 [MHz].

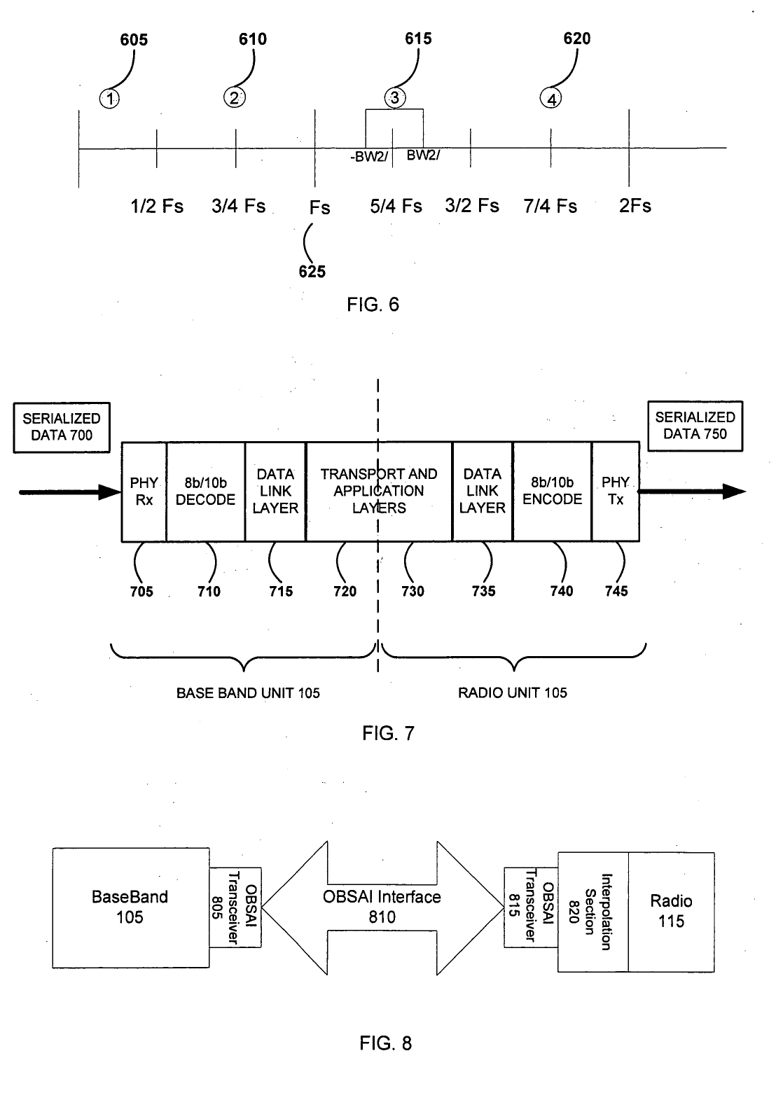

Reference is now made to FIG. 9, which is a simplified block diagram of interpolations in a single Tx path in the base station 100 of FIG. 1A.

FIG. 9 depicts an example of interpolations in a forward, Tx, path for, by way of a non-limiting example, a 10 [MHz] carrier channel.

Interleaved I,Q data 902 is passed to the base station 100, in which up-conversion to a DAC sampling clock rate is handled through various digital interpolation stages.

A first stage L1 905 stage includes performing, by way of the above 10 [MHz] carrier channel example, interpolation and sampling at a sampling frequency of somewhat higher than 10 [MHz].

A following stage is optionally performed by an NCO 910, sampling at a yet higher base band rate. The NCO 910 is optionally used for fine frequency corrections.

A third stage includes performing CFR 915, using a Farrow filter. The Farrow filter performs interpolation by approximately 2.

A following stage includes performing DPD 920.

It is noted that the CFR and the DPD are performed digitally.

A following stage L2 925 includes performing further interpolation at a yet higher sampling rate.

A following stage is performed by an NCO 930, optionally sampling at a rate equal to the sampling rate of the L2 925. The NCO 930 optionally translates the signal carrying the data to an IF frequency.

A following stage L3 935 includes performing her interpolation, sampling at a yet higher rate.

A following stage is performed by a DAC 940, and includes Digital to Analog Conversion. The DAC 940 optionally receives a DAC clock signal 945, optionally at a high-IF rate.

It is noted that the L3 stage may optionally be performed inside the DAC 940, in which case the DAC is an interpolating DAC.

A broken line 950 demarcates stages of the up-conversion process, termed a BB clock domain 955, in which a BB clock is optionally used to generate the sampling frequencies, from stages in which the DAC clock signal 945 is optionally used to generate the sampling frequencies.

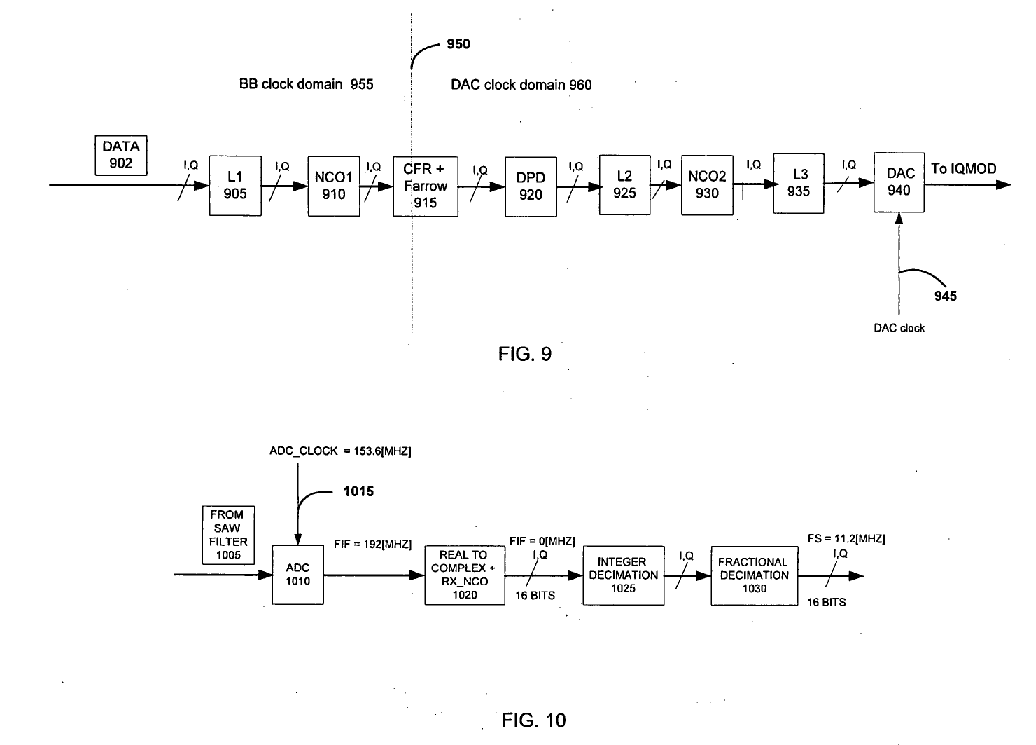

Reference is now made to FIG. 10, which is a simplified block diagram of a single chain Rx path in the base station 100 of FIG. 1A.

FIG. 10 also depicts, by way of a non-limiting example, a 10 [MHz] carrier channel.

A signal in the Rx path, is filtered by a SAW filter (not shown). The signal after filtering 1005 is a real signal, and is sampled by an ADC 1010. The ADC 1010 optionally samples at an IF frequency, by way of a non-limiting example at approximately 200 [MHz]. The ADC 1010 optionally receives an ADC clock signal 1015 at a frequency of 153.6 [MHz].

The output of the ADC 1010 is then digitally down-converted to DC by an NCO 1020. After bringing the sampled signal to DC the result is decimated to a BB frequency. Since conversion from the sampling frequency to the BB frequency is optionally not an integer number, decimation by an integer number 1025 is performed, followed by decimation by a fractional number 1030. The result is a signal at 11.2 [MHz].

An alternative embodiment of the invention performs the decimation by a fractional number 1030 first, followed by the decimation by an integer number 1025.

Example decimation ratios corresponding to different channel bandwidths of 5, 7, 10, and 20 [MHz], taking into account suitable sampling rates for the different channel bandwidths, are: 153.6./[5.6, 8, 11.2, and 22.4]=[27.4286, 19.2000, 13.7143, and 6.8571].

Bandwidth (BW) Requirements

BW requirements in the transmit path are optionally derived from some and/or all of: DPD methodic requirements, a polynomial model of the PA, the order of the polynomial order, and how close to linear the PA is made. Due to clock rate requirements, the DPD expansion factor in 20 [MHz] channels is optionally limited to 120 [MHz] which is approximately 6 channel bandwidths. It is noted that in channel BWs of 5, 7, and 10 [MHz], the DPD expansion factor is higher. By way of a non-limiting example, for a 10 [MHz] channel BW even an 11^{th} order inter-modulation product is optionally eliminated.

Hence, some and/or all analog filters in the forward path are optionally 140 [MHz], except the optional cavity filter (optionally included in the transmit/receive separator 455 of FIG. 4), which is optionally 110 [MHz]. The cavity filter, however, does not affect the DPD method, since it is located after a directional coupler (the PA 450 of FIG. 4).

In a DPD-Rx feedback path the analog (LC) filter bandwidth (BPF 470 of FIG. 4) optionally has a large bandwidth, larger than the signal bandwidth, in order not to attenuate information needed for pre-distortion method operation and for speeding up convergence time. The ADC in the feedback path (ADC 475 of FIG. 4) optionally samples with a clock rate of 256 [MHz] which is sufficient to represent faithfully a feedback signal in the digital domain, for purpose of DPD error computation.

Two Carrier Channels

Two carriers of 5, 7, or 10 [MHz] each, can be digitally multiplexed in the RU to form a single 10, 14 or 20 [MHz] carrier channel. The multiplexing of the two carriers is done digitally in the radio unit before CFR and DPD are applied. Hence, the two carriers are placed without spacing in the frequency domain. A sub-carrier numbered 1 of a second 7 or 10 [MHz] carrier channel is placed in the frequency domain immediately to the right of a sub-carrier numbered 1024 of a first carrier channel. Thus, the two carrier channels form a virtual 2048 sub-carrier signal which is equivalent to a single 14 or 20 [MHz] RF channel.

Practically, for a 10 [MHz] carrier channel the multiplexing is done as a very first stage by multiplying, before the digital interpolation, the first 10 [MHz] carrier by e^{-j2π5e6nT} and the second 10 [MHz] carrier by e^{j2π5e6nT}, thereby forming a single 20 [MHz] channel. Mathematically, the first carrier channel is represented as x₁(nT) and the second carrier is represented as x₂(nT). The BB transmitted signal thru the digital interface is represented as y(nT). Therefore: y(nT)=[x₁(nT)x₂(nT)]^{II}.

The 20 [MHz] equivalent signal z(nT) is formed by the following mathematical operation:

$$z ( nT ) = {x}_{1} ( nT ) {e}^{- j2π 5 e 6 nT} + {x}_{2} ( nT ) {e}^{j2π 5 e 6 nT} \\ where \\ T = \frac{1}{{f}_{BB}} . \qquad Equation 1$$

In an exemplary embodiment of the invention, upon receiving a signal containing two carrier channels on one RF channel, the signal is digitally down-converted to base-band frequency, and the two carrier channels are separated using a separation filter. The two carrier channels are further processed by two base-band receivers.

Generally, there can be more than two carriers digitally multiplexed on one RF channel.

The Calibration Process

Calibration is optionally used for purposes such as, by way of a non-limiting example, beam forming (BF). Different methods of BF are termed simple BF, BF+nulling, and Down Link-Spatial Division Multiple Access (DL_SDMA).

Calibration for BF and BF+nulling optionally relies on reciprocal calibration, that is calibration of a Tx path transfer function with reference to an Rx path transfer function.

DL-SDMA optionally relies on calibration of each Tx path relative to other Tx paths. Thus, in DL-SDMA, calibration optionally calibrates so that

$$\frac{{H\_Tx}_{i} ( f )}{{H\_Tx}_{j} ( f )} ≅ 1$$

In BF/SDMA a base-band weighting matrix W which is used on the Tx side optionally relies on channel estimation, which is based upon sounding symbol transmission by a Mobile Station (MS). Since an over the air channel is considered reciprocal, in order that an estimated channel in the base station UL estimation be valid in the DL, a non-reciprocal part which includes the BS hardware is optionally calibrated. More specifically, the radio unit hardware is optionally calibrated.

A basic calibration procedure included in an embodiment of the invention relies on reciprocity. A calibration mechanism calibrates, by using calibration transmissions in the RF hardware so that:

$$\frac{{H\_RX}_{k} ( f )}{{H\_TX}_{k} ( f )} ≅ 1 \qquad Equation 2$$

Where H_Txₖ(f) and H_Rxₖ(f) are transfer functions of a transmit path Tx and a receive path Rx respectively.

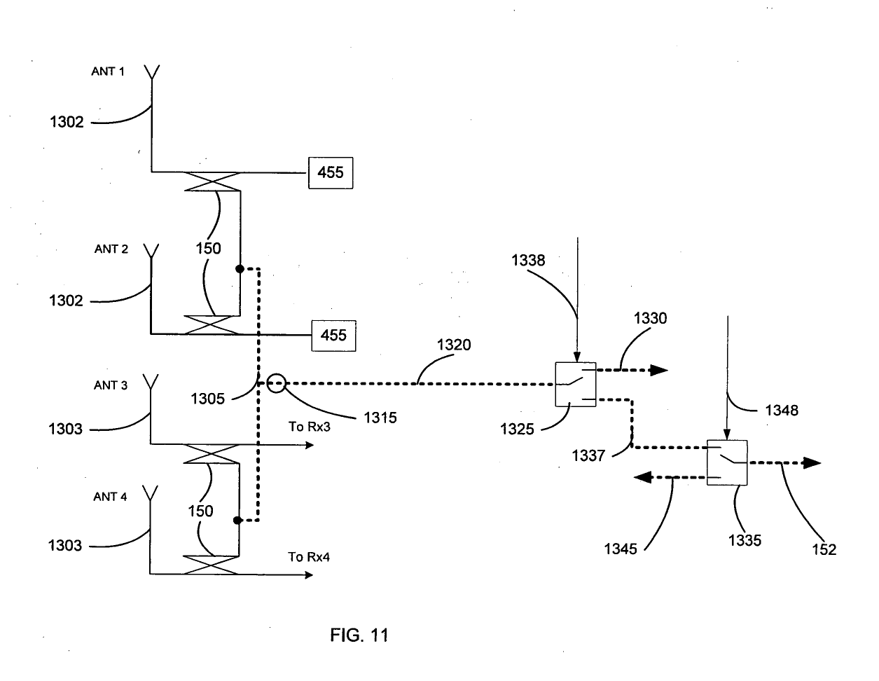

In some embodiments of the invention, additional hardware is optionally introduced for antenna array calibration. In one example embodiment depicted in FIG. 11 and described below with reference to FIG. 11, dedicated calibration transmit and receive paths are introduced.

The dedicated calibration transmit path is optionally piggybacked on a regular Tx path. The dedicated calibration transmit path transmits regular transmissions, but instead of passing the regular transmissions via a PA, such as the PA 450 of FIG. 4, the regular transmissions are directed via a path 151 (FIG. 1) to a dedicated calibration port via switches. From the calibration port, the regular transmissions are returned, via an RF splitter, to each of the radio Rx chains.

Calibration is optionally performed in two stages.

In a first stage a transfer function of Rx paths is measured, per frequency, by transmitting via a dedicated Tx path and receiving with all Rx paths being calibrated. As described above a signal is transmitted using the Tx radio path to the calibration port. Using a radio splitter the signal is returned to each radio Rx path. The signal is optionally passed via the TDD switches, LNAs, and the rest of the Rx path. The transfer function of each Rx path is optionally measured by comparing the signal transmitted via the dedicated Tx path with the signal output at the end of each Rx path.

In a second stage a transfer function of Tx paths is measured, and reception is performed via a dedicated Rx path. A signal is transmitted from all the Tx paths being calibrated. Using a coupler and a splitter the signal is directed to the dedicated Rx path, optionally using a set of switches to bypass the LNA and TDD switch, and the transfer function is measured per frequency. The transfer function of each Tx path is optionally measured by comparing the signal transmitted via each Tx path with the signal output at the end of the dedicated Rx path.

Denote a reciprocal over the air channel as Hₖ(f) for a k-th antenna. On the Rx side, per each antenna, measure H_Rxₖ(f)Hₖ(f) for k=1 . . . 4. On the Tx path, transmit Hₖ(f)H_Txₖ(f) for k=1.4.

The calibration procedure optionally performs self-calibration of the, by way of a non-limiting example, four-antenna array. Self-calibration implies that an external calibration unit is optionally not used.

For the self-calibration one chain of the four chains available transmits, which is assumed without a loss of generality to be the chain of antenna 1. The Tx path of antenna 1 transmits a calibration transmission. The calibration transmission does not pass through the PA or the PA driver. The calibration transmission is routed via dedicated hardware to a calibration port, and used as described further below, with reference to FIG. 11.

Reference is now made to FIG. 11, which is a simplified block diagram illustration of a calibration path in the base station of FIG. 1A.

FIG. 11 depicts four antennas 1302 1303, and a calibration connection 1305, operatively connected to the four antennas 1302 1303 by four couplers 150. The calibration connection 1305 passes through a calibration port 1315, which is, by way of a non-limiting example, a port in a radio unit such as the radio unit 115 of FIG. 1A. The calibration connection 1305 is operatively connected to a switch 1325.

It is noted that the calibration connection 1305 is a connection which carries a signal 1320 from the couplers 150 of FIG. 1B, the signal 235 of FIG. 2, the feedback signal 370 of FIG. 3, and the output signal 465 of FIG. 4.

The switch 1325 either optionally connects a signal provided through the calibration connection 1305 to a Tx calibration path 1330, or optionally connects the signal to an additional switch 1335, via a connection 1337 based on a selection signal 1338.

The additional switch 1335 either connects the signal to the path 152 (also in FIG. 1B) for DPD, or connects the signal to a Rx calibration path 1345, based on a selection signal 1348. The signal carried by the Rx calibration path 1345 is the signal depicted on FIG. 1B as the input signal 132.

It is noted that the antennas 1302 1303 correspond to the antennas 120 of FIGS. 1A and 1B, the antennas 380 of FIG. 3 and the antenna 460 of FIGS. 4 and 5A.

It is noted that FIG. 11 depicts two antennas 1302 in transmission mode, and two antennas 1303 in reception mode.

It is noted that the couplers 150 picking up a calibration signal are connected to the transmission antennas 1302 between the transmit/receive separators 455 and the antennas 1302.

Returning now to the calibration transmission, the transmitted signal goes through the calibration port 1315 to each of the four antennae calibration paths 1345. The BB unit receives responses, in the frequency domain, as follows: H_Tx1×H_Rx1 for the Rx1 path, H_Tx1×H_Rx2 for the Rx2 path, H_Tx1×H_Rx3 for the Rx3 path, and H_Tx1×H_Rx4 for the Rx4 path.

Due to optionally shared RF LO architecture, there is optionally no issue of phase difference or phase drift between different Rx paths.

After calibrating the Rx chains, the Tx chains are calibrated.

The Tx paths Tx1 . . . Tx4 transmit calibration transmissions, one by one, and the four calibration transmission are passed to one Rx path, by way of a non-limiting example, the Rx path of antenna 1.

The received responses, in the frequency domain are: [H_Tx1×H_Rx1, H_Tx2×H_Rx1, H_Tx3×H_Rx1, H_Tx4×H_Rx1], corresponding to the four Tx signals passing through the one Rx path.

Dividing the first response by the second response produces:

[1, (H_Tx2/H_Rx2)/(H_Tx1/H_Rx1), (H_Tx3/H Rx3/(H_Tx1/H_Rx1), (H_Tx4/H_Rx4)/(H_Tx1/H_Rx1)]

The above is rewritten as:

C _calibₖ=(H_{—}TXₖ/H_{—}RXₖ)(H_{—}TX₁/H_{—}RX₁) Equation 3.

For k=1 . . . 4.

Equation 3 defines a calibration vector which is used in the BB unit for performing reciprocal BF and for setting a BF weighting matrix Wₖ. The BF weighting matrix is set as follows:

$$\begin{matrix}{W}_{k} = {C\_calib}_{k} . * {H\_RX}_{k} \\ = ( \frac{{H\_TX}_{k}}{{H\_RX}_{k}} ) / ( \frac{{H\_TX}_{1}}{{H\_RX}_{1}} ) . * {H\_RX}_{k} .\end{matrix} \qquad Equation 4$$

Where * denotes multiplication of each sub-carrier by each sub-carrier, in the frequency domain. The BE weighting matrix is set with W_{BF,k}=Wₖ^{H}, where the subscript H denotes the Hermitian operator, the beam-formed channel, per sub-carrier, as a Mobile Station receives, is given by Equation 5:

$$\begin{matrix}{\tilde{H}}_{k} ( f ) = {W}_{BF , k} {H}_{k} ( f ) {H\_TX}_{k} ( f ) \\ = \sum \frac{1}{{( {H\_TX}_{1} ( f ) / {H\_RX}_{1} ( f ) )}^{H}} \\ ( {\vert {H}_{k} ( f ) . * {H\_TX}_{k} ( f ) \vert}^{2} )\end{matrix}$$

where, the Σ is due to matrix multiplication of the BF weighting matrix by an aggregate channel response (Tx+over the air channel).

Thus, calibrating separately for Rx paths and for Tx paths, a reciprocal calibration is performed for BF and BF+nulling.

For purpose of DL-SDMA, the calibration mechanism calibrates relative transfer functions between Tx chains. The DL-SDMA calibration is similar to the reciprocal calibration method. DL-SDMA calibration can be regarded as an addition to reciprocal calibration. After finalizing the reciprocal calibration, a transmitter calibration stage is performed in which relative phase and gains of each of the Tx paths is calibrated for purpose of achieving sharp and accurate beams.

It is noted that since Tx chains optionally transmit using DPD, which is adaptively converged based on a same shared feedback path, variability between different Tx chains is minimized, thereby achieving DL-SDMA calibration.

Reference is now made to FIG. 12, which is a simplified block diagram illustration of a SAW calibration path in the base station of FIG. 1A.

An input signal 1205 from a antenna (not shown) is provided to a transmit/receive separator 455, which corresponds to the transmit/receive separator 455 of FIGS. 1B, 4, and 5A. Output from the transmit/receive separator 455 is provided to an LNA 510 which corresponds to the LNA 510 of FIG. 5A.

Output from the LNA 510 is provided to a switch SW1 1210. The switch SW1 1210 outputs one of two signals input into the switch SW1 1210: either the output of the LNA 510, or a Tx feedback and calibration sample 1207.

Output from the switch SW1 1210 is provided to an Rx mixer 440, which corresponds to the mixer 440 of FIG. 4, where it is mixed with an analog RF LO signal 512, which corresponds to the analog RF LO signal 512 of FIG. 5A. Output of the Rx mixer 440 is provided to a BPF 520, which corresponds to the BPF 520 of FIG. 5A. Output of the BPF 520 is provided to a PGA 525, which corresponds to the PGA 525 of FIG. 5A.

Output from the PGA 525 is provided to a switch SW2 1215. The switch SW2 1215 outputs to one of two paths: either to the DPD via an ADC 530, which corresponds to the ADC 530 of FIG. 5A; or to a switch SW3 1220.

The switch SW3 1220 outputs to one of a plurality of SAW calibration paths. Each one of the SAW calibration paths passes a signal via a SAW 1225, to a PGA 1230, and via the PGA 1230 to an ADC 1235. Output from the ADC 1235 is sent to a Digital Down-Converter (DDC). The DDC performs rate reduction (decimation) and translation of a received incoming signal from digital high-IF to DC.

SAW calibration for any one of the SAW filters is performed by the switches SW1 inputting a Tx feedback and calibration sample 1207, and by the switch SW2 1215 routing a signal through one of the SAWs.

Selecting a specific SAW filter to calibrate is optionally done using SW3 1220. Thus, the Tx feedback and calibration sample 1207 passes through a shared Rx mixer 440, is mixed with a shared RF_LO signal 512, and is then passed through one of the SAW filters.

It is noted that a transfer function of a SAW filter is defined by comparing an initial Tx BB signal and a corresponding Rx BB signal which passed through a SAW calibration path. Changes in the transfer function of the SAW filter over time, that is, from frame to frame, are typically caused by temperature drift of the SAW filter.

It is noted that the SAW calibration optionally shares the feedback path with the DPD, using Time Division Multiplexing.

It is noted that FIG. 12 depicts a single SAW calibration path which comprises the SAW 1225, the PGA 1230, and the ADC 1235. Calibration paths for additional SAWs are similar.

It is expected that during the life of a patent maturing from this application many relevant interface protocols such as the Open Base Station Architecture Initiative (OBSAI) interface or the Common Public Radio interface (CPRI) will be developed and the scope of the term “base-band to radio unit interface” is intended to include all such new technologies a priori.

As used herein the terms “about” and “approximately” refer to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A multi-transmitter base station for wireless digital communication, having beam forming and digital pre-distortion capabilities, comprising a shared feedback unit for providing feedback of outgoing Radio Frequency (RF) signals, for calibrating a plurality of antennas, and for adapting the digital pre-distortion.

2. The base station of claim 1 and further comprising multiple receivers, in which at least one receiver shares components with the shared feedback unit.

3. The base station of claim 1 in which there is only one analog Radio-Frequency (RF) Local Oscillator (LO).

4. The base station of claim 3 in which the one analog RF LO is used simultaneously for transmitting, receiving, and providing feedback for calibration.

5. The base station of claim 3 and further comprising multiple receivers, in which at least one receiver shares a RF LO with at least one transmitter.

6. The base station of claim 1 in which the base station comprises:
a base band unit which receives input of digital communication and encodes the digital communication;
a radio unit which accepts an input comprising the encoded digital communication at an intermediate frequency (IF) substantially lower than the RF LO frequency;
a Radio-Frequency (RF) Local Oscillator (LO) which is comprised in the radio unit; and
the base station is packaged in a plurality of enclosures.

7. The base station of claim 6 in which the radio unit is configured to accept an Open Base Station Architecture Initiative (OBSAI) compliant input.

8. The base station of claim 6 in which the radio unit is configured to accept a Common Public Radio Interface (CPRI) compliant input.

9. The base station of claim 6 in which the radio unit is configured to accept an optical input.

10. The base station of claim 6 in which one or more of the enclosures are packaged for outdoors operation.

11. A multi-transmitter base station for wireless digital communication, having a feedback unit acting as a mux/demux for all feedback and calibration signals, shunting the feedback and calibration signals to their respective destinations.

12. The base station of claim 11 in which the feedback unit shares some components with a receive path.

13. A multi-transmitter base station for wireless digital communication comprising multiple receivers, in which at least one receiver shares an analog RF LO with at least one transmitter.

14. The base station of claim 13 in which there is only one analog RF LO.

15. The base station of claim 14 and further comprising multiple receivers, in which all receivers share the analog RF LO with all transmitters.

16. A method of calibration in a multi-receiver base station for wireless digital communication having at least one transmit path comprising:
providing a transmission signal through the transmit path;
prior to power amplification, routing the transmission signal, back through a plurality of receive paths; and
measuring transfer functions of signals by comparing the transmission signal to signals received through the plurality of the receive paths.

17. The method of claim 16 in which the transmission signal is shunted from the transmit path prior to power amplification, and the routing back through a plurality of receive paths comprises feeding the transmission signal to receive antennas.

18. The method of claim 16 in which the routing further comprises routing the transmission signal back through the plurality of receive paths using a shared feedback unit.

19. The method of claim 16 in which the providing, routing, and measuring are performed at least once for each of a plurality of different signal frequencies.

20. The method of claim 16 in which the routing the transmission signal is performed by a shared feedback unit.

21. The method of claim 16 in which at least some of the plurality of receive paths are calibrated, based, at least partly, on the measuring.

22. The method of claim 16 in which at least some of the plurality of receive paths share one Radio-Frequency (RF) Local Oscillator (LO).

23. The method of claim 16 in which all of the plurality of receive paths share the one RF LO.

24. The method of claim 16 in which at least some of the plurality of receive paths comprise a SAW filter.

25. A method of calibration in a multi-transmitter base station for wireless digital communication having at least one receive path comprising:
providing a transmission signal through a plurality of transmit paths;
routing the transmission signal back through the receive path; and
measuring transfer functions of signals by comparing the transmission signal to signals received through each one of at least some of the plurality of transmit paths and the receive path.

26. The method of claim 25 in which the routing further comprises routing the transmission signal back through the reception path using a shared feedback unit.

27. The method of claim 25 in which the providing, routing, and measuring are performed at least once for each of a plurality of different signal frequencies.

28. The method of claim 25 in which the routing the transmission signal is performed by a shared feedback unit.

29. The method of claim 25 in which at least some of the plurality of transmit paths is calibrated based, at least partly, on the measuring.

30. The method of claim 25 in which at least some of the plurality of transmit paths share one Radio-Frequency (RF) Local Oscillator (LO).

31. The method of claim 25 in which the receive path shares the one RF LO.

32. The method of claim 25 in which all of the plurality of transmit paths share the one RF LO.

33. The method of claim 25 in which at least some of the plurality of transmit paths comprise a SAW filter.

34. A method for calibrating receive paths and transmit paths in a base station for wireless digital communication having a plurality of receive paths and transmit paths comprising:
providing a first transmission signal through a transmit path;
prior to power amplification, routing the first transmission signal back through a plurality of receive paths;
measuring a first set of transfer functions by comparing the first transmission signal to signals received through at least some of the plurality of the receive paths;
providing a second transmission signal through a plurality of transmit paths;
routing the second transmission signal back through a receive path;
measuring a second set of transfer functions of signals by comparing the second transmission signal to a signal received through at least some of the plurality of transmit paths and the receive path; and
calibrating at least some of the transmit paths and receive paths based, at least partly, on the first set and the second set.

35. The method of claim 34 in which the routing the first transmission signal and the routing the second transmission signal comprise routing via a shared feedback unit.

36. The method of claim 34 in which the providing, routing, measuring and calibrating are performed at least once for each of a plurality of different signal frequencies.

37. The method of claim 34 in which routing the first transmission signal and routing the second transmission signal are performed by a shared feedback unit.

38. A method for transmitting via multiple transmit paths in a multi-transmitter base station for wireless digital communication comprising sharing a single Radio-Frequency (RF) Local Oscillator (LO) between more than one transmit path.

39. A multi-transmitter base station for wireless digital communication configured to perform self calibration of a plurality of receive paths, in which at least some of the plurality of receive paths share a Radio-Frequency (RF) Local Oscillator (LO), comprising:
means for providing a transmission signal through a transmit path;
means for routing the transmission signal, prior to power amplification, back through the plurality of receive paths; and
means for measuring transfer functions of signals by comparing the transmission signal to signals received through the plurality of the receive paths.

40. The base station of claim 39 in which all of the plurality of receive paths share the one RF LO.

41. A multi-transmitter base station for wireless digital communication configured to perform self calibration of a plurality of transmit paths, in which at least some of the plurality of transmit paths share a Radio-Frequency (RF) Local Oscillator (LO), comprising:
means for providing a transmission signal through the plurality of transmit paths;
means for routing the transmission signal back through a receive path; and
means for measuring transfer functions of signals by comparing the transmission signal to signals received through each one of at least some of the plurality of transmit paths and the receive path.

42. The base station of claim 41 in which all of the plurality of transmit paths share the one RF LO.

43. A multi-transmitter base station for wireless digital communication comprising:
a base band unit which receives input of digital communication and encoding the digital communication, configured for digital operation at frequencies lower than Radio Frequency (RE); and
a radio unit which operates at frequencies including RF, wherein:
the base band unit and the radio unit communicate with each other at frequencies lower than RF;
the base band unit and the radio unit are packaged in separate modular units; and
the base station is configured to comprise a plurality of at least one of the base band unit and the radio unit.

44. The base station of claim 43 in which the base band unit and the radio unit communicate with each other using a physical connection from the group consisting of a wire connection and an optical fiber.

45. The base station of claim 43 in which the base band unit and the radio unit are configured to communicate with each other at an Intermediate Frequency (IF).

46. The base station of claim 43 in which the base band unit and the radio unit are configured to communicate with each other at a base band frequency.

47. The base station of claim 43 in which the base station is configured so that base band units can be added to the base station.

48. The base station of claim 43 in which the base station is configured so that radio units can be added to the base station.

49. A multi-transmitter base station for wireless digital communication comprising:
a master unit configured to supply Radio-Frequency (RF) Local Oscillator (LO) signals for the base station; and
one or more auxiliary units configured to receive the RF LO signals from the master unit and provide functionality of at least one of a transmit path and a receive path.

50. The base station of claim 49 in which the master unit provides all the RF LO signals for the base station.

51. The base station of claim 49 in which the master unit provides clock signals for the base station.

52. The base station of claim 51 in which the master unit provides all the clock signals for the base station.

53. The base station of claim 49 in which:
the base station is configured so that auxiliary units can be added to the base station and receive the RF LO signals from the master unit; and
the auxiliary units are configured to receive the RF LO signals from the master unit and provide the functionality.

54. The base station of claim 49 in which the base station is configured so that the auxiliary units can be removed from the base station, and the auxiliary units remaining in the base station are configured to continue to receive the RF LO signals from the master unit and to provide the functionality.
